(19) United States
(12) Patent Application Publication
(10) Pub. No.: US 2013/0297333 A1
(43) Pub. Date: Nov. 7, 2013

(54) SYSTEMS AND METHODS FOR ELECTRONIC PRESCRIBING

(71) Applicant: OMNICARE, INC., Cincinnati, OH (US)

(72) Inventors: Gina L. Timmons, Englewood, OH (US); Anthony Diaz, Cincinnati, OH (US)

(73) Assignee: OMNICARE, INC., Cincinnati, OH (US)

(21) Appl. No.: 13/796,192

(22) Filed: Mar. 12, 2013

Related U.S. Application Data
(60) Provisional application No. 61/642,965, filed on May 4, 2012.

(51) Int. Cl. G06F 19/00

(52) U.S. Cl. CPC G06F 19/3456
USPC 705/2

(57) ABSTRACT

Methods, systems, and computer program products for the generation and processing of electronic prescriptions. An application server receives user input data that identifies a particular facility and a particular patient. Based at least in part on the particular facility and the particular patient, the application server may generate application data for electronic prescribing for the particular patient. The application server receives prescription for the particular patient and generates an electronic prescription for the particular patient based at least in part on the received prescription data.

### CROSS-REFERENCE TO RELATED APPLICATIONS

This application claims the benefit of U.S. Provisional Application No. 61/642,965, filed May 4, 2012, which is hereby incorporated by reference herein in its entirety.

### FIELD OF THE INVENTION

The invention is generally related to computer systems, and in particular to methods, systems, and computer program products for generating and processing electronic prescriptions.

### BACKGROUND

Prescribing a medication for a patient conventionally requires an authorized healthcare professional (e.g., a physician, nurse practitioner, physician's assistant, dentist, etc.) to sign a paper prescription (wet ink signature). The signed paper prescription may then be taken by the patient to a pharmacy for filling, or the prescription may be faxed to a pharmacy for filling, as permitted by laws/regulations. As with many other paper based transactions requiring signature authorization, forgery of a prescription and/or altering of a prescription present an opportunity for a medication to be diverted without a valid prescription. In addition, the physical nature of a paper prescription creates difficulty tracking medical prescription transactions, including for example, prescriptions for a particular patient, prescriptions generated by a particular healthcare professional, prescriptions filled by a pharmacy, etc. Furthermore, transmitting a paper prescription to a pharmacy, even by fax machine, may lead to incorrect prescription filling due to illegibility of the paper prescription.

Therefore, a need exists in the art for improved systems and methods, as well as improved computer program products, for prescribing medications.

### SUMMARY OF THE INVENTION

Embodiments of the invention generally comprise methods, systems, and computer program products for the generation and processing of electronic prescriptions.

In an embodiment, user input data that identifies a particular facility and a particular patient is received at an application server. The application server generates application data for electronic prescribing for the particular patient based at least in part on the particular facility and the particular patient. Prescription data for the particular patient is received at the application server, and the application server generates an electronic prescription for the particular patient based on the prescription data.

In an embodiment, an electronic prescription that includes a prescription image may be processed by an application server. In these embodiments, the application server analyzes the prescription image to determine a user certificate database location and a signature code included in the prescription image. The application server communicates the determined user certificate database location and signature code to a verification server, and the application server receives validation data from the verification server indicating whether the prescription image is valid or invalid.

In an embodiment, a verification server may process received prescription data to thereby sign the prescription data for an electronic prescription. In these embodiments, the verification server receives prescription data and a request for an identification data transmission from an application server. The verification server generates first identification data for a particular user based on the request in response to receiving the request. The first identification data is transmitted by the verification server to a user device associated with the particular user, where the user device is identified in the request. The verification server receives second identification data, and the verification server analyzes the second identification data to determine whether the second identification data corresponds to the first identification data. If the second identification data corresponds to the first identification data, the verification server signs the prescription data.

### BRIEF DESCRIPTION OF THE DRAWINGS

The accompanying drawings, which are incorporated in and constitute a part of this specification, illustrate various embodiments of the invention and, together with a general description of the invention given above and the detailed description of the embodiments given below, serve to explain the embodiments of the invention.

FIG. 1 is a block diagram of an application server, a verification server, a pharmacy server, and multiple user devices in communication with the servers to perform electronic prescribing consistent with embodiments of the invention.

FIG. 2A is a block diagram of one of the user devices of FIG. 1.

FIG. 2B is a block diagram of the application server of FIG. 1.

FIG. 2C is a block diagram of the verification server of FIG. 1.

FIG. 2D is a block diagram of the pharmacy server of FIG. 1.

FIG. 3 is an example routine in the form of a sequence diagram that may be performed by one or more of the user devices, the application server, and the verification server shown in FIG. 1 as a procedure to generate a signed electronic prescription.

FIG. 4 is an example routine in the form of a sequence diagram that may be performed by one or more of the user devices, the application server, and the verification server shown in FIG. 1 as a procedure to generate a signed electronic prescription.

FIG. 5 is a flowchart illustrating a flow of operations that may be performed by the application server of FIG. 1 as a procedure to interface with the user devices of FIG. 1.

FIG. 6 is a flowchart illustrating a flow of operations that may be performed by one of the user devices and the application server of FIG. 1 as a procedure to interface therebetween.

FIG. 7 is a flowchart illustrating a flow of operations that may be performed by the application server of FIG. 1 as a procedure to generate an electronic prescription.

FIG. 8 is a flowchart illustrating a flow of operations that may be performed by one of the user devices and the application server of FIG. 1 as a procedure to interface therebetween.

FIG. 9 is a flowchart illustrating a flow of operations that may be performed by any of the user devices of FIG. 1 as a procedure to interface with the application server and input prescription data for an electronic prescription.

FIG. 10 is a flowchart illustrating a flow of operations that may be performed by the application server and verification server of FIG. 1 as a procedure to validate an electronic prescription.

FIGS. 11A-T are example output screens that may be displayed by one of the user devices while interfacing with the application server of FIG. 1.

FIGS. 12A-Q are example output screens that may be displayed by one of the user devices while interfacing with the application server of FIG. 1.

### DETAILED DESCRIPTION

Embodiments of the invention address problems associated with conventional systems and methods for prescribing medications, whether controlled substances, non-controlled substances, or even over-the-counter substances. Embodiments of the invention are generally directed to systems and/or methods for the electronic prescribing of a medication, where a medication may generally be considered a prescription medication or an over-the-counter (OTC) medication, and where a prescription medication may be a controlled substance or a non-controlled substance. Generally, a “prescription” drug/medication may be defined as such by one or more government laws/regulations; hence, what medications constitute “prescription” medications generally varies depending applicable laws/regulations. Likewise, a “controlled” substance is generally defined as such by government law/regulation. For example, the United States Drug Enforcement Agency (DEA) issues a schedule of controlled drugs and provides a schedule assigning a classification number to each controlled drug. Each classification number (a “class”) is regulated differently.

In some embodiments of the invention, a user (e.g., a healthcare practitioner such as a licensed physician) may interface with a computing device including a processor and a memory and configured to perform operations to facilitate electronic prescribing of medications, where the computing device configured to perform such operations may be referred to herein as an “application server.” The user may interface with the application server to generate an electronic prescription of a particular medication for a particular patient who is a resident at a particular facility. The user may utilize a computing device including a processor and a memory (referred to herein as a “user device”) to communicate with the application server to log in to the application server, identify the particular facility, identify the particular patient, and input details of the prescription (e.g., the medication name, dose amount, dosing instructions, refill information, etc.). The ability of a user, such as a physician, to enter, review, sign, and send prescriptions for controlled substances, as well as other types of substances, electronically provides for increased accuracy and accountability when prescribing medications.

Furthermore, the user may interface with a computing device including a processor and a memory and configured to perform operations to authenticate or verify the user's identity such that unauthorized users may not generate electronic prescriptions, where the computing device configured to perform such operations may be referred to herein as a “verification server.” A verification server consistent with embodiments of the invention may comprise a third party verification service which may communicate with the application server to transparently verify a user's identity. In some embodiments, the verification server may be maintained by a pharmacy and interconnected/execute in parallel with the application server. The ability to prescribe substances and, in particular, the ability to prescribe controlled substances is regulated, and the prescriptions themselves are also regulated. The user may utilize a user device to communicate with the verification server to receive generated identification information from the verification server and provide identification information to the verification server. Following verification of the user's identity, the verification server may include an electronic signature data associated with the user in the electronic prescription to thereby “sign” the electronic prescription in compliance with regulatory requirements. A signed electronic prescription may be communicated to a server associated with a pharmacy (i.e., a “pharmacy server”) such that the signed electronic prescription may be filled by the pharmacy and, in at least some embodiments, filled by the pharmacy with paperless authorization.

In some embodiments of the invention, a healthcare facility, such as a long-term care facility, an assisted living facility, a hospital, a prison, and/or any other such facilities that provide healthcare services for patients, may utilize remote pharmacy services. In general, such a facility may contract/associate with a remote pharmacy provider, such that the remote pharmacy provider may provide some or all pharmacy services for patients of the facility, including filling prescriptions for controlled substances, non-controlled substances, and/or over-the-counter substances for patients of the facility. In these embodiments, a prescriber servicing patients that are residents at an associated facility may interface with an application server consistent with embodiments of the invention to electronically prescribe medications for the patients.

The prescriber may register with the application server as a user, and the application server may access data from accessible databases corresponding to registered users (“user records”), associated facilities (“facility records), and/or patients of the associated facilities (“patient records”). The application server may generally be considered a front-end interface with the remote pharmacy, and the application server may provide to a registered user a guided interface for completing and submitting an electronic prescription to the remote pharmacy for a particular patient of an associated facility. Such a guided interface may be based at least in part on a user record corresponding to the registered user, a patient record corresponding to the particular patient, and/or a facility record corresponding to the associated facility of the particular patient. In these embodiments, the application server may securely communicate with a pharmacy server of the remote pharmacy and format electronic prescriptions in a data format expected by the pharmacy server.

In conventional electronic prescription systems, a prescriber may generally complete an electronic prescription at a user device, and submit the electronic prescription over a communication channel of a third party to a pharmacy server of any pharmacy that accepts electronic prescriptions. Control of an electronic prescription in such systems generally changes during generation, communication, and filling. As such, diversion and/or forgery of an electronic prescription may still be possible. To guard against such diversion and/or forgery a pharmacy may be required to perform prescription validation prior to filling the prescription, where the prescription validation required by law/regulation for electronic prescribing of medications (whether controlled, non-controlled, and/or over-the-counter) may not be possible due to the limitations of these conventional systems. Furthermore, in conventional electronic prescription systems, the user device the prescriber may utilize to complete an electronic prescription typically may not access data for the prescriber, patient, and/or facility. Hence, the prescriber may be required to enter such information, and moreover, the user device may not guide the prescriber in generation of the electronic prescription, as the user device will not be able to access any information related to the patient or user.

In contrast, an application server and pharmacy server consistent with some embodiments of the invention may be considered a closed system for a remote pharmacy, where the user records, patient records, and/or facility records may be accessible to the application server and the pharmacy server. The application server may be configured to communicate signed electronic prescriptions exclusively to the pharmacy server, and the pharmacy server may be configured to receive and process electronic prescriptions originating from the application server exclusively, and the communication therebetween may be secured. Therefore, generation of an electronic prescription, communication of an electronic prescription and filling of an electronic prescription may remain under the control of the remote pharmacy, and may therefore reduce the possibility of diversion/forgery of an electronic prescription. As such, a registered user utilizing a user device interfacing with an application server of such closed system embodiments may be guided in generating an electronic prescription for a patient of a facility associated with the remote pharmacy. The interface provided to the user device of the registered user may be based on the user record, patient record, and/or facility record, where the existing relationship between the associated facility and the remote pharmacy may be leveraged to create a closed pharmacy system for prescribers providing care to patients of the associated facilities. In other words, the known number of associated facilities, the limited number of patients of such facilities, and the limited number of registered users (i.e., prescribers providing healthcare services to patients of the associated facilities) facilitates a closed electronic prescription system. A closed electronic prescription system consistent with some embodiments of the invention may create an increased level of security associated with electronic prescriptions generated therefrom as compared to other conventional electronic prescription systems. In addition, such closed electronic prescribing systems consistent with some embodiments of the invention may be more efficient for associated facilities as opposed to other electronic prescribing systems.

Moreover, data records corresponding to the associated facilities, patients of the associated facilities, and registered users may be utilized by the application server to provide a guided interface for generating electronic prescriptions, verifying the identity of a registered user, validating the electronic prescription and submitting the electronic prescriptions to the remote pharmacy. For example, based on the associated facility at which a particular patient is receiving care, the application server may limit a user's ability to prescribe medications to thereby comply with laws and/or regulations for a geographic region in which the associated facility is located. In this example, an associated facility may be located in a state which prohibits the electronic prescribing of controlled substances, and a registered user would not be able to input data for a controlled substance when interfacing with the application server to generate an electronic prescription. In another example, the application server may access a user record corresponding to a registered user to determine a particular communication channel (e.g., an email address, a phone number, a cellular phone number) with which the registered user's identification may be verified.

While embodiments of the invention have been described as including an application server, a pharmacy server and/or a verification server, the invention is not so limited. In some embodiments of the invention, one or more interconnected computing systems comprising one or more servers may perform one or more operations generally described with respect to the application server, pharmacy server and/or verification server in any combination. For example, in embodiments of the invention which may be described as a “closed system,” the application server and pharmacy server may comprise one interconnected group of computing devices generally referred to as a server.

In some embodiments of the invention, an application server may select one or more prescribing rules from an accessible prescribing rules database. Such prescribing rules may correspond to geographic regions, where the prescribing rules may include information related to laws/regulations of each geographic region for the electronic prescribing of medications. In these embodiments, a user may select a particular healthcare facility having a particular patient that the user wishes to fill out an electronic prescription when interfacing with the application server using a user device. A geographic region may be determined based on the selected healthcare facility, and one or more prescribing rules corresponding to the geographic region may be selected based on the determined geographic region. Subsequent interfacing between the user device and the application server may be based on the selected prescribing rules, such that during input of prescription information by the user for the particular patient of the selected healthcare facility, only medications legally permitted to be electronically prescribed for the determined geographic region may be input by the user and/or included in an electronic prescription.

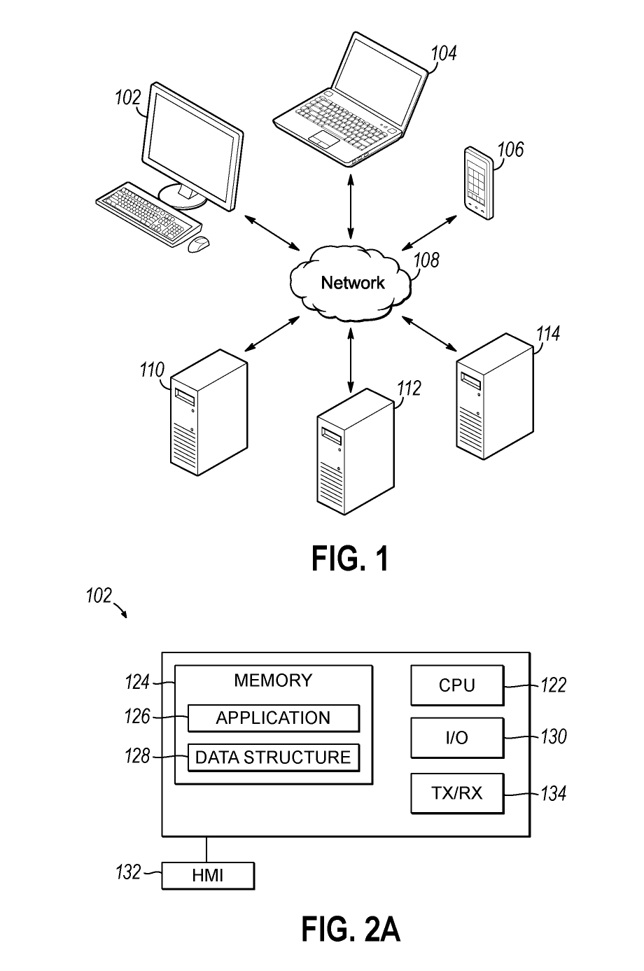

With reference to FIG. 1, a plurality of devices are configured as a system 100 to generate, process, and transmit electronic prescriptions of medications consistent with embodiments of the invention. As shown in FIG. 1, one or more user devices 102, 104, 106 may be connected to a communication network 108, such that the user devices 102, 104, 106 may remotely communicate with one or more servers 110, 112, 114 connected to the communication network 108. In a representative embodiment, user device 102 may be embodied in a personal/desktop computer, user device 104 may be embodied in a portable computer (e.g., laptop computer, tablet computer, and/or other such portable computing devices), and user device 106 may be embodied in a mobile computing device, such as a cellular telephone, smart phone, personal data assistant or other such devices consistent with some embodiments of the invention. The one or more servers 110, 112, 114 may communicate with each of the user devices 102, 104, 106 and/or another server over the communication network to receive data for an electronic prescription, verify the identity of a user entering such data, validate such electronic prescription, and transmit a validated electronic prescription to a pharmacy server such that a pharmacy associated with the pharmacy server may fill the electronic prescription.

Network 108 generally comprises one or more interconnected communication networks, including for example, a cellular communication network, a local area network (LAN), a wide area network (WAN), public networks (e.g., the Internet), an enterprise private network, and/or combinations thereof. Network interfaces of the user devices 102, 104, 106 and the servers 110, 112, 114 may employ one or more suitable communication protocols defining rules and data formats for exchanging information and communicating over the network 108, such as User Datagram Protocol/Internet Protocol (UDP/IP), and/or Transmission Control Protocol/Internet Protocol (TCP/IP). The user devices 102, 104, 106 and the servers 110, 112, 114 may connect to the network 108 via a hardwired link, such as an IEEE 802.3 (Ethernet) link, a wireless link using a wireless network protocol, such as an 802.11 (Wi-Fi) link, or any other suitable link for interfacing with the network 108.

Consistent with some embodiments of the invention, a user may interface with the application server 110 utilizing user device 102 to thereby select a patient of the user and input prescription data for a prescription for the patient. In the description hereinbelow, this interaction between the user and the application server 110 will be discussed in the context of the use of user device 102 with an understanding that the discussion equally applies to user device 104 or to user device 106. Following input of the prescription data, the user may interface with the verification server 112 utilizing the user device 102 to verify the identity of the user. In response to verifying the identity of the user, the verification server 112 may include an electronic signature associated with the user in the prescription data to generate electronically signed prescription data. Furthermore, the verification server 112 may send already electronically signed prescription data after receiving an unsigned version of the prescription data and the user's identity has been verified. The application server 110 may generate a digital image of a prescription based on the electronically signed prescription data, and may analyze machine readable indicia on the digital image to determine a database location of a digital certificate associated with the prescription and a signature code included on the prescription. The application server 110 may communicate over network 108 with the verification server 112 and, based on a certificate at the determined certificate location, verify the signature code on the digital image. After verifying the signature code on the digital image of the prescription, the application server 110 may communicate prescription fill request data including the validated digital image of the prescription over network 108 to the pharmacy server 114, such that the pharmacy associated with the pharmacy server 114 may fill the prescription.

The application server 110, the verification server 112, and the pharmacy server 114 may generally comprise one or more interconnected computing devices/systems located locally and/or remotely. For example, while the servers 110, 112, 114 have been illustrated as individual computing systems, embodiments of the invention are not so limited. One or more interconnected computing systems may be configured to perform one or more operations associated with the application server 110, verification server 112, and/or pharmacy server 114.

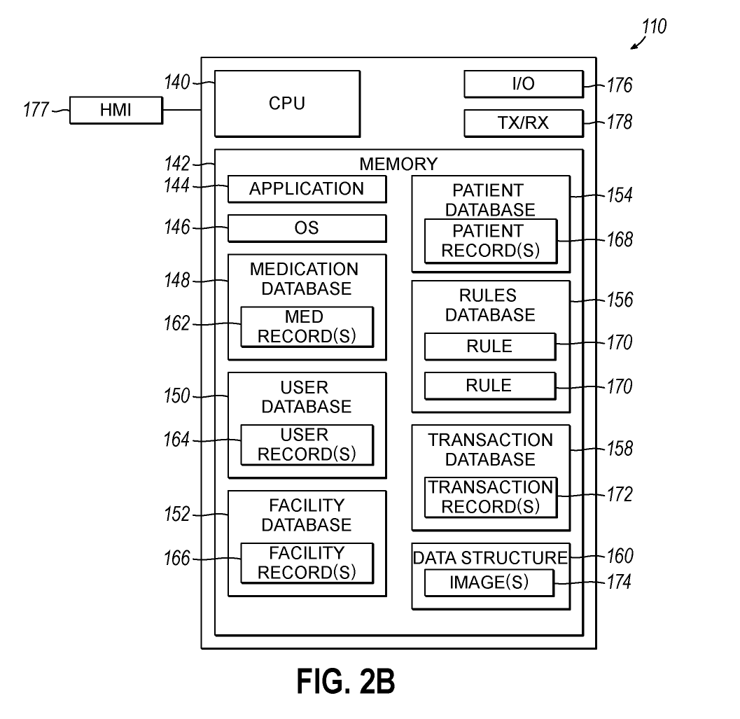

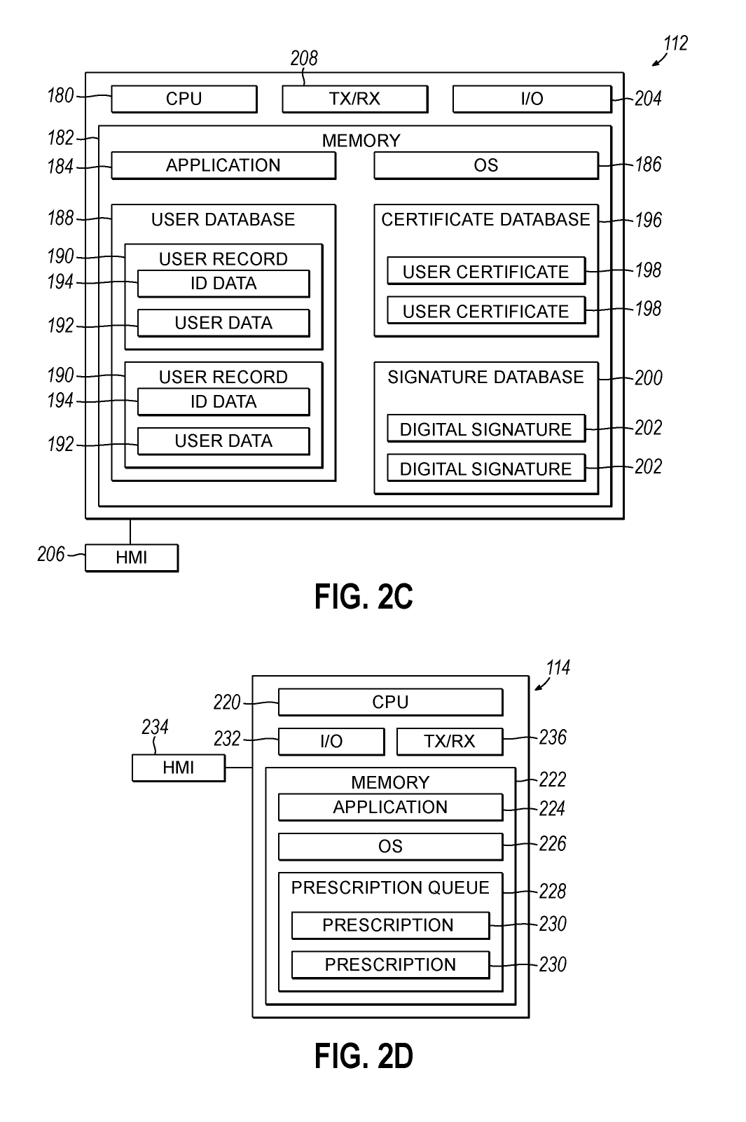

With reference to FIG. 2A in which like reference numerals refer to like features in FIG. 1 and in accordance with an embodiment of the invention, the user device 102 includes one or more processors (illustrated as ‘CPU’) 122 for executing one or more instructions to perform and/or cause components of the user device 102 to perform one or more operations consistent with embodiments of the invention. The user device 102 includes a memory 124, and an application 126 and a data structure 128 stored by the memory 124. User device 102 further includes an input/output (“I/O”) interface 130, and a human-machine interface (“HMI”) 132. User device 102 is representative of user devices 104, 106, which may each be structurally and/or functionally similar or identical to user device 102.

Application 126 may generally comprise program code that when executed by the processor 122 facilitates interfacing between a user of the user device 102 and the servers 110, 112, 114 illustrated in FIG. 1. Accordingly, a user may input data for the generation of an electronic prescription for a particular patient and input data to confirm the user's identity, and the electronic prescription may be transmitted to the pharmacy server 114 of a pharmacy for fulfillment.

The memory 124 may represent random access memory (RAM) comprising the main storage of a computer, as well as any supplemental levels of memory, e.g., cache memories, non-volatile or backup memories (e.g., programmable or flash memories), mass storage memory, read-only memories (ROM), etc. In addition, the memory 124 may be considered to include memory storage physically located elsewhere, e.g., cache memory in a processor of any computing system in communication with the user device 102, as well as any storage device on any computing system in communication with the user device 102 (e.g., a remote storage database, a memory device of a remote computing device, cloud storage, etc.).

The I/O interface 130 of user device 102 may be configured to receive data from input sources and output data to output sources. For example, the I/O interface 130 may receive input data from a user input device such as a keyboard, mouse, microphone, touch screen, and other such user input devices, and the I/O interface 130 may output data to one or more user output devices such as a display (e.g., a computer monitor), a touch screen, speakers, and/or other such output devices that may be used to output data in a format understandable to a user. Such input and output devices are generally represented in FIG. 2A as the human-machine interface (“HMI”) 132. As such, in some embodiments of the invention, user input data may be communicated to the processor 122 of the user device 102 using a user input device such as a keyboard or touch screen utilizing the I/O interface 130.

The user device 102 may include a network interface controller (Tx/Rx) 134 that is configured to transmit data to one or more of the servers 110, 112, 114 and/or receive data from one or more of the servers 110, 112, 114 over the network 108. For example, the physical connection between the network 108 and user device 102 may be supplied by a network interface card, an adapter, or a transceiver.

In one specific implementation that may, for example, apply to a mobile device embodied as user device 106, the application 126 may be implemented as a downloadable application, such as supported by Android and iOS operating systems available from Open Handset Alliance and Apple Computer, respectively, or in other forms of program code as appropriate for a particular mobile device. The application 126 may also be implemented as a web application downloaded from application server 110, or even via web pages communicated by the application server 110. Furthermore, multiple mobile devices and operating systems may be supported by a central service such that mobile devices from different vendors may utilize the same central service. In some embodiments, the application 126 may be downloaded from an external source including for example, a network accessible location (e.g., a mobile application store, an accessible database), a computer-readable storage media, and/or other such external sources.

With reference to FIG. 2B in which like reference numerals refer to like features in FIG. 1 and in accordance with an embodiment of the invention, the application server 110 includes one or more processors 140 configured to execute instructions to perform one or more operations consistent with embodiments of the invention. The application server 110 further includes memory 142 accessible by the one or more processors 140. The memory 142 stores an application 144 and/or an operating system 146, where the application 144 and/or operating system 146 includes instructions in the form of program code that may be executed by the processor 140 to perform or cause to be performed one or more operations consistent with embodiments of the invention. Generally, execution of the application 144 and/or operating system 146 by the processor 140 may cause the application server 110 to communicate with the user device 102 (or alternatively either user device 104 or user device 106) over the communication network 108 of FIG. 1 to receive input from a user using the user device 102 to log the user in to a secure electronic prescription system, generate an electronic prescription, communicate with the verification server of FIG. 1 to verify the user's identity, generate a digital image of the signed electronic prescription, and transmit the a prescription request including the digital image to the pharmacy server.

As shown in FIG. 2B, the memory 142 includes a plurality of data structures 148, 150, 152, 154, 156, 158, 160. As discussed above with respect to the user device 102, the memory 142 shown in FIG. 2B may represent local memory and/or remote memory. As such, while the memory 142 is illustrated in FIG. 2B as one component, the invention is not so limited. In some embodiments the memory 142 may comprise remote memory accessible to the processor 140 and located in one or more remote computing systems, including for example, one or more interconnected data servers accessible over one or more communication networks. Hence, while data structures 148, 150, 152, 154, 156, 158, 160 are illustrated in FIG. 2B as located in memory 142 in application server 110, in some embodiments, the data structures 148, 150, 152, 156, 158, 160 may be physically located in memory of one or more remote memory locations accessible by the processor 140, including remote memory locations associated with the pharmacy server 114. The memory 142 also includes a database management system in the form of a computer program that, when executing as instructions on the processor 140, is used to access the information or data stored in the records of the data structures 148, 150, 152, 156, 158, 160.

Memory 142 includes a medication database 148, where the medication database 148 includes one or more medication records 162. Each of the medication records 162 may include data associated with a particular medication, such as the name of the medication, common dose strengths of the medication, dosing instructions associated with the medication, type of delivery associated with the medication, whether the medication requires a prescription, a United States Drug Enforcement Agency (DEA) Controlled Substance Schedule Classification (hereinafter “drug class” or “schedule”) associated with the medication, and/or other such relevant information. For example, Schedule II Controlled Substances have a high potential for abuse that may cause severe psychological or physical dependence. Exemplary substances in this schedule include oxycodone, methylphenidate, and fentanyl. As another example, Schedule III Controlled Substances have a lower potential for abuse than Schedule II Controlled Substances and abuse may cause low or moderate physical dependence or high psychological dependence. The DEA Classification continues with Schedule IV Controlled Substances and Schedule V Controlled Substances that possess progressively lower potentials for abuse. Non-controlled substances may also be included in the medication records 162 in the medication database 148.

Memory 142 also includes a user database 150, where the user database 150 includes one or more user records 164. Each of the user records 164 includes data associated with a user that may log in and interface with the application server 110, such as the user's name, the user's title at a healthcare facility, one or more government-issued or facility-issued identification numbers associated with the user, patients associated with the user, healthcare facilities at which the user has patients, personal information for the user (e.g., address, phone number, etc.), and/or any other such relevant information. The user record 164 may also include user credentials, such as a user name and a password or personal identification number (PIN) that is assigned to the user name, for use in accessing the application server and/or verifying a user's identity with a verification server.

Memory 142 includes a facility database 152 including one or more facility records 166. Each of the facility records 166 may be associated with a particular facility, where a particular facility may be, for example, a long-term care facility, a hospital, a prison, and/or other such facilities which provide healthcare services. Each facility record may include data for the associated facility including the name of the facility, the address of the facility, patients associated with the facility, users associated with the facility, the types of specific care units (e.g., an assisted living facility, a long term care facility, a hospital, a combination of an assisted living facility and a long term care facility, etc.) associated with the facility, and/or other such information.

Memory 142 also includes a patient database 154 storing one or more patient records 168. Each of the patient records 168 is associated with a particular patient and includes data indicating the patient's name, address, personal data (e.g., age, date of birth, gender, social security number, etc.), one or more physicians associated with the patient, the facility or facilities at which the patient is a resident, insurance information for the patient, allergies of the patient, medications prescribed to the patient, medical history of the patient (e.g., diagnosed illnesses, operations performed on the patient, health events for the patient, etc.), and/or other such information that may be relevant for a healthcare facility, a healthcare provider, and/or a pharmacy.

Memory 142 further includes a rules database 156, where the rules database 156 includes a plurality of prescription rules 170. The prescription rules 170 indicate rules for prescribing medications for geographic regions and may vary among different geographic regions. For example, in the United States, the rules database 156 may store prescription rules 170 of each state and/or U.S. territory that has specific laws or regulations as well as any federal laws/regulations related to the electronic prescribing of medications. Each prescription rule 170 may include data indicating the particular laws and/or regulations for electronic prescribing for a particular geographic region in a format that may be read by the processor 140, and the application 144 may perform one or more operations based on the retrieved prescription rule(s) 170 for a particular geographic region. Consistent with some embodiments, a prescription rule 170 for a particular geographic region may include data for different types of facilities for the particular geographic region. For example, a particular state may have different electronic prescription laws/regulations for long term care facilities and hospitals, as such, depending on the type of facility that a patient is receiving care in, the application server 110 may interface with the user device 102 differently such that the correct rules/regulations for the geographic region and type of facility are enforced in the generation of an electronic prescription for the patient.

A prescription rule 170 for an associated geographic region may include data indicating medications and/or types of medications that may be electronically prescribed for the associated geographic region, prescribing limits (e.g., number of refills, quantity of the prescription, dosage of the prescription, etc.) for medications and/or types of medications, professionals authorized to electronically prescribe medications, and/or other such criteria that may be defined by laws or regulations for the particular geographic region. As an example, if a particular state prohibits electronic prescribing of Schedule II Controlled Substances but allows electronic prescribing of Schedule III, IV, and V Controlled Substances, a prescription rule 170 for the particular state may include data indicating that the electronic prescribing of Schedule II Controlled Substances is prohibited and that the electronic prescribing of other schedules or classes of drugs is allowed. Accordingly, a user may be prohibited by application of the state-specific prescription rule 170 from inputting prescription data for a Schedule II Controlled Substance, when interfacing or interacting with the application server 110, if the patient for whom the electronic prescription is being generated is located in the particular state. The limiting of the user's ability to electronically prescribe Schedule II Controlled Substances is based on the indication of such prohibition by a prescription rule 170 for the particular state, which may be mandated by regulation. The application of a prescription rule 170 when generating an electronic prescription will be described in detail below.

The memory 142 includes a transaction database 158 including one or more transaction records 172. A transaction record 172 generally stores data for a particular transaction performed by interfacing with the application server 110, including for example generation of an electronic prescription, preventing a user from generating an electronic prescription, log-in of a user to interface with the application server, transmission of an electronic prescription to the pharmacy server, and/or other such relevant transactions. A transaction record 172 may store data indicating the user associated with the transaction, the patient associated with the transaction, the prescription data of the transaction, a digital image of the electronic prescription, the time and date of the transaction, and/or other such relevant information. The memory 142 further includes one or more generalized data structures 160 which may store data in a format which the processor 140 may read and/or write. In this example embodiment, the data structure 160 includes one or more digital images 174. As described above, in some embodiments, the application server 110 may generate a digital image of a prescription based on signed prescription data, and in these embodiments, the application server 110 may store a generated digital image 174 of the prescription. The digital images 174 maintained in the data structure 160 may be used to establish complete and accurate prescription records, which are easily readable or can easily be rendered into a format that a person can read.

While in FIG. 2B, the medication database 148, user database 150, facility database 152, patient database 154, rules database 156 and transaction database 158 are illustrated as separate database structures in the memory 142, the invention is not so limited. The application server 170 may comprise one or more database structures storing the data described with respect to the medication database 148, user database 150, facility database 152, patient database 154, rules database 156 and transaction database 158 in any database organization and/or structure, including for example relational databases, hierarchical databases, network databases, and/or combinations thereof.

The application server 110 further includes an input/output (“I/O”) interface 176, where the I/O interface 176 may be configured to receive data from input sources and output data to output sources. For example, the I/O interface 176 may receive input data from a user input device such as a keyboard, mouse, microphone, touch screen, and other such user input devices, and the I/O interface 176 may output data to one or more user output devices such as a computer monitor, a touch screen, speakers, and/or other such output devices that may be used to output data in a format understandable to a user. Such input and output devices are generally represented in FIG. 2B as an HMI 177. As such, in some embodiments of the invention, input data may be communicated to the processor 140 of the application server 110 using a user input device such as a keyboard or touch screen utilizing the I/O interface 176. Furthermore, as discussed previously, in some embodiments, the application server 110 may comprise a plurality of interconnected computing devices located locally and/or remotely. As such, in these embodiments data may be input to the application server 110 via an HMI 177 and I/O interface 176 located remote from the computing device including a processor 140 and/or a memory 142. The application server 110 may include a network interface controller (Tx/Rx) 178, where data may be transmitted and/or received over the network 108 of FIG. 1 using each network connection device 178. For example, the physical connection between the network 108 and application server 110 may be supplied by a network interface card, an adapter, or transceiver.

With reference to FIG. 2C in which like reference numerals refer to like features in FIG. 1 and in accordance with an embodiment of the invention, the verification server 112 includes one or more processors 180 configured to execute instructions to perform one or more operations consistent with embodiments of the invention. In addition, the verification server 112 includes a memory 182 accessible by one or more processors 180 of the verification server 112. The memory stores an application 184 and/or an operating system 186, where the application 184 and/or operating system 186 includes instructions in the form of program code that may be executed by the processor 180 to perform or cause to be performed one or more operations consistent with embodiments of the invention. The memory 182 also includes a database management system in the form of a computer program that, when executing as instructions on the processor 180, is used to access the information or data stored in the records of data structures 188, 196, 200. The verification server 112 may provide identity credentials to users of system 100 and provide real-time transactional identity assurance.

In addition, the memory 182 of the verification server 112 includes a user database 188 including a plurality of user records 190, where each user record corresponds to a user authorized to sign electronic prescriptions. Each of the user records 190 may include user data 192 corresponding to the particular user, including for example, the name of the user, business address of the user, telephone number associated with the user, an email address of the user, government issued identification numbers associated with the user (e.g., a DEA prescriber identification number, a National Provider Identifier (NPI) for the Health Insurance Portability and Accountability Act (HIPAA) Administrative Simplification Standard, a medical license number, and/or other such types of identifiers associated with the user), facilities associated with the user, job title of the user, patients associated with the user, and/or other such relevant information. In addition, the user data 192 may include data associated with the signing of an electronic prescription, including one or more database references to other databases storing data/information associated with the user, including for example a database reference data indicating a database location for a digital signature associated with the user and/or a database reference indicating a database location for a digital certificate associated with the user. While the user database 150 of the verification server 112 and the user database 150 of the application server 110 are illustrated as separate, the invention is not so limited, and the verification server 112 and/or the application server 110 may utilize the same or different user databases.

Furthermore, each user record 190 includes identification data 194 associated with the user, where the verification server 112 may compare data input by the user at the user device 102 and communicated to the verification server 112 with the identification data 194 to verify the user's identity. Such identification data may include, for example a password, data associated with a biometric identifier of the user (e.g., a fingerprint scan, a retina scan, a voice sample, etc.), a unique key code associated with a hard token in the user's possession (e.g., a magnetic key card, a radio frequency identification (RFID) item, etc.), and/or other such types of identification data which may be used to verify a user's identity.

In some embodiments, the identification data 194 may include a generated password which may be communicated to a particular communication channel controlled by the user such that the user may enter the generated password at the user device to verify the user's identity. For example, the verification server 112 may generate a password for a particular user in response to receiving a request to transmit identification data from the application server 110 with which the particular user is interfacing using user device 102 to generate an electronic prescription. The verification server 112 may transmit data indicating the generated password to a cellular telephone number included in the user data 192 associated with the particular user. For example, the verification server 112 may conduct an automated telephone call to the cellular telephone number and transmit voice data indicating the generated password. In another example, the verification server 112 may transmit text messaging data to the cellular telephone number indicating the generated password. As another example, the verification server 112 may transmit email data to an email address indicated in the user data 192 associated with the particular user, where the email data indicates the generated password. In another example, the verification server 112 may interface with a device controlled by the particular user directly, including for example a mobile computing device executing an application to interface with the verification server 112, and the verification server 112 may communicate data to the mobile computing device, where the data may be output to a screen/display of the mobile computing device and the output may indicate the generated password. In some embodiments, the user device 102 may utilize a predefined algorithm to generate a random number that may correspond to a number expected by the application server 110 and/or verification server 112. In some embodiments, the generated password may only be valid for a predefined time, such that the user is required input the generated password into the user device for communication to the verification server 112 before the predefined time limit expires.

As shown in FIG. 2C, the memory 182 may further include a certificate database 196 storing a plurality of digital certificates 198. Each digital certificate 198 is associated with a particular user. In addition, the memory 182 may include a digital signature database 200 storing a plurality of digital signatures 202. In an alternative embodiment, the databases 196, 200 may be located at a different server remote from verification server 112, but in communication with the verification server 112. Each digital signature 202 is associated with a user certificate and a particular user authorized to sign an electronic prescription. In some embodiments, prior to transmitting a signed electronic prescription to a pharmacy server 114, the application server 110 may analyze the signed electronic prescription to determine a database location of a digital certificate 198 associated with a particular user and an electronic signature in the electronic prescription associated with the user, and the application server 110 may query the verification server 112 to locate the digital certificate 198 at the determined location and verify that the electronic signature in the electronic prescription corresponds to the digital signature 202 stored at the verification server 112 using the user certificate at the determined location, thereby indicating that electronic prescription is validly signed. In some embodiments of the invention, a public version of the digital certificate 198 may be included in the signed prescription data, and the application server 110 may analyze the electronic signature based on the public version of the digital certificate to determine whether the electronic prescription is validly signed.

The verification server 112 further includes an input/output (“I/O”) interface 204, where the I/O interface 204 may be configured to receive data from input sources and output data to output sources. For example, the I/O interface 204 may receive input data from a user input device such as a keyboard, mouse, microphone, touch screen, and other such user input devices, and the I/O interface 204 may output data to one or more user output devices such as a computer monitor, a touch screen, speakers, and/or other such output devices that may be used to output data in a format understandable to a user. Such input and output devices are generally represented in FIG. 2C as an HMI 206. As such, in some embodiments of the invention, input data may be communicated to the processor 180 of the verification server 112 using a user input device such as a keyboard or touch screen utilizing the I/O interface 204. Furthermore, as discussed previously, in some embodiments, the verification server 112 may comprise a plurality of interconnected computing devices located locally and/or remotely. As such, in these embodiments data may be input to the verification server 112 via an HMI 206 and I/O interface 204 located remote from the computing device including a processor 180 and/or a memory 182. The verification server 112 may include a network interface controller (Tx/Rx) 208, where data may be transmitted and/or received over the network 108 of FIG. 1 using each network connection device 208. For example, the physical connection between the network 108 and application server 112 may be supplied by a network interface card, an adapter, or a transceiver.

With reference to FIG. 2D in which like reference numerals refer to like features in FIG. 1 and in accordance with an embodiment of the invention, the pharmacy server 114 includes one or more processors 220, where the one or more processors 220 are configured to execute instructions to perform one or more operations consistent with embodiments of the invention. In addition, the pharmacy server 114 includes a memory 222 accessible by the one or more processors 220 of the pharmacy server 114. The memory 222 stores an application 224 and/or an operating system 226, where the application 224 and/or operating system 226 includes instructions in the form of program code that may be executed by the processor 220 to perform or cause to be performed one or more operations consistent with embodiments of the invention. The memory 222 further includes a prescription queue data structure 228 configured to store one or more electronic prescriptions 230. In some embodiments of the invention, an application server may transmit electronic prescription data to the pharmacy server 114 such that the electronic prescription may be filled by a pharmacy associated with the pharmacy server 114, and the electronic prescriptions 230 may be stored in the prescription queue structure 228 for processing and filling.

The pharmacy server 114 further includes an input/output (“I/O”) interface 232, where the I/O interface 232 may be configured to receive data from input sources and output data to output sources. For example, the I/O interface 232 may receive input data from a user input device such as a keyboard, mouse, microphone, touch screen, and other such user input devices, and the I/O interface 232 may output data to one or more user output devices such as a computer monitor, a touch screen, speakers, and/or other such output devices that may be used to output data in a format understandable to a user. Such input and output devices are generally represented in FIG. 2C as an HMI 234. As such, in some embodiments of the invention, input data may be communicated to the processor 220 of the pharmacy server 114 using a user input device such as a keyboard or touch screen utilizing the I/O interface 232. Furthermore, as discussed previously, in some embodiments, the pharmacy server 114 may comprise a plurality of interconnected computing devices located locally and/or remotely. As such, in these embodiments data may be input to the pharmacy server 114 via an HMI 234 and I/O interface 232 located remote from the computing device including a processor 220 and/or a memory 222. The pharmacy server 114 may include a network interface controller (Tx/Rx) 236, where data may be transmitted and/or received over the network 108 of FIG. 1 using each network connection device 236. For example, the physical connection between the network 108 and pharmacy server 114 may be supplied by a network interface card, an adapter, or a transceiver.

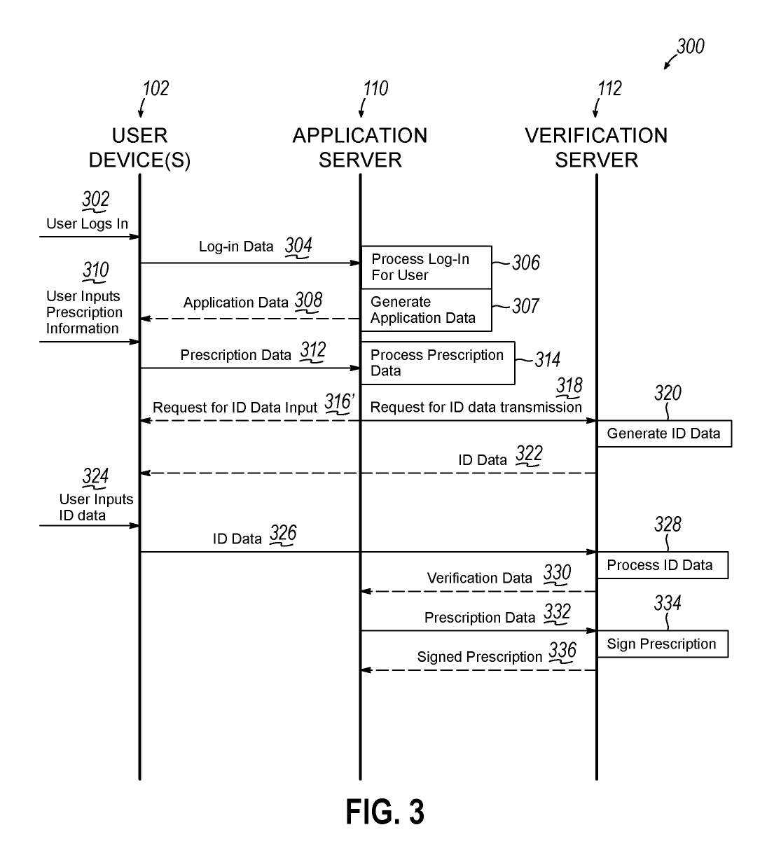

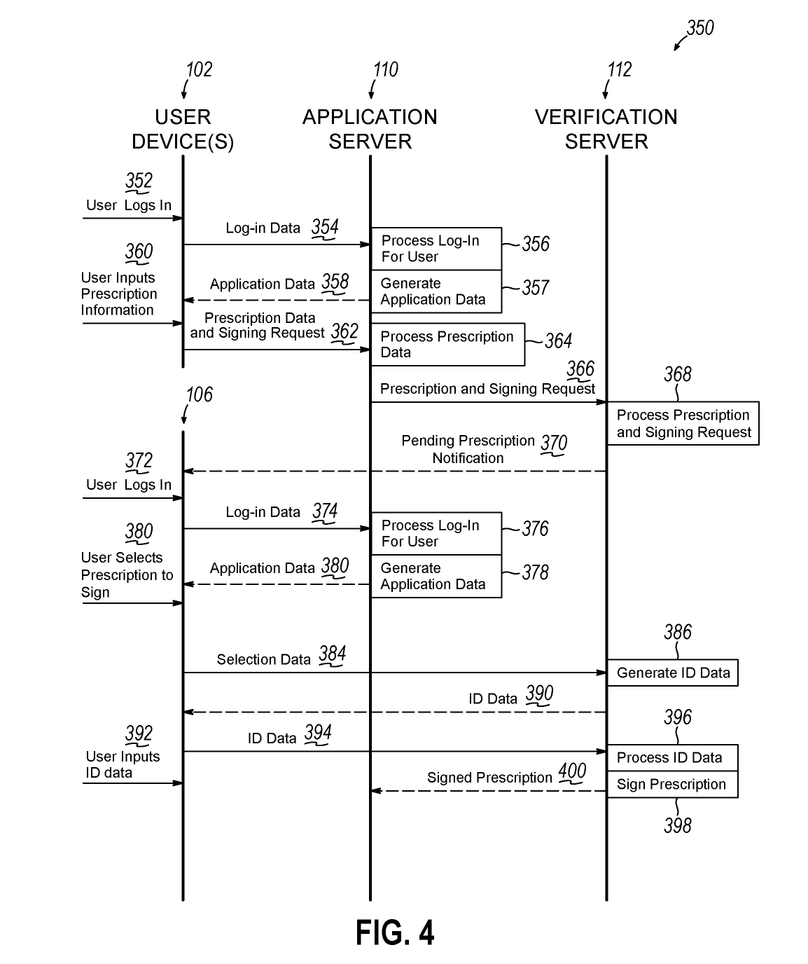

FIGS. 3 and 4 provide exemplary routines that may be performed by systems consistent with some embodiments of the invention to generate a signed electronic prescription.

With reference to FIG. 3 and in accordance with an embodiment of the invention, a routine 300 illustrates a sequence of operations that may be performed by the user devices 102, 104, 106, the application server 110 and the verification server 112 of FIG. 1 to generate a signed electronic prescription for a particular medication to a particular patient. As shown in routine 300, a user may utilize user device 102 to interface with an application server 110 and the verification server 112, where the solid and dashed arrows shown in FIG. 3 represent the input from the user to the user device and/or communication of data between the user device 102, the application server 110, and/or the verification server 112.

In this example, the user logs-in to the application server 110 via user device 102 by inputting log-in data to the user device 102 (block 302). For example, the user may input a user name and a password, scan a hard token using a scanner in communication with the user device 102, scan a biometric feature using a scanner in communication with user device 102, and/or other such methods for identification to gain secure access to the application server 110. The user device 102 communicates the log-in data to the application server 110 (block 304). The application server 110 processes the log-in data and confirms whether the log-in data is valid (block 306) based on data contained in the corresponding user record 164 stored in the user database 150 accessible by the application server 110. For example, the application server 110 may compare a password received with the log-in data to a stored password in one of the user records 164 associated with the user name received with the log-in data.

If the user is authenticated, then the application server 110 generates application data (block 307) using the executing application 144, and communicates the application data to the user device 102 (block 308). In some embodiments, the application server 110 may generate the application data based on the user record 164 associated with the user associated with the log-in data, where the user record 164 may be stored in the user database 150 accessible by the application server 110. For example, the application server 110 may generate application data including one or more healthcare facilities associated with the user, one or more patients associated with the user at each healthcare facility, and/or other such information. The user device 102 is configured to receive the application data and to output the received application data on the HMI 132 for display to the user. The user may use the HMI 132 to make selections and/or input data pertaining to prescription information, such as the facility, the patient at the facility, and the details of each prescribed medication for the patient.

The user may input responses via the HMI 132 of the user device 102 in reaction to prompts supplied on the HMI 132 by the application 126 and reflecting the application data received from the application server 110. The user device 102 receives the prescription information (block 310) as input. In some embodiments, the output application data from the application server 110 may cause the application 126 to display or present a list of facilities associated with the user on the HMI 132. The user may select a specific facility from the displayed list using the HMI 132. Following selection of the specific facility, the output application data from the application server 110 may cause the application 126 on the HMI 132 to present a group or list of patients associated with the user and physically located at the selected facility. The user may use the HMI 132 to select a particular patient from the displayed patient list. The application data may cause the user device 102 to display a health record for the patient, which may include existing prescriptions associated with the patient. In some embodiments, the output application data may cause the application 126 to display a list of facilities associated with the user and patients associated with the user and each facility simultaneously for the user to select a patient therefrom using the HMI 132.

The output application data from the application server 110 may then cause the application 126 to present the user with one or more data fields for the order associated with the prescription, which are displayed by the HMI 132. The user may input data (medication name, frequency of administration, refill frequency, etc.) detailing the particular prescribed medication into the data fields using the HMI 132. The data may be input as free text into the data fields or data entry into the data fields may be assisted by a drop-down list that provides predictive suggestions the user. Regulations may define the content of the required input date.

The prescription information input by the user at the user device 102 may be communicated as prescription data by the user device 102 over the network 108 for receipt at the application server 110 (block 312). As will be described in detail below, the prescription data may be communicated as a series of communications over the network 108 between the user device 102 and the application server 110, where the user may incrementally input data and the application server 110 may incrementally communicate updated application data to the user device 102 in response to receiving the incrementally-inputted user data. For example, the user may input the particular drug name for the medication into a text field, and the application server 110 may update a text field displayed on the user device 102 with a common dosage form and dosage strength associated with the particular medication and/or alternative dosage forms and dosage strengths. A drug library (e.g., medication database 148) may be accessed to derive the displayed information. Hence, in some embodiments, the prescription data may be communicated from the user device 102 to the application server 110 in sequential portions, and the application server 110 may update and communicate application data to the user device 102 in response to receiving each portion.

The application server 110 processes the prescription data (block 314) and communicates application data to the user device 102 requesting that the user input identification data into the user device (block 316). In this example routine 300, the application server 110 communicates a request for the user to transmit additional identification data to the verification server 112 (block 318) in order to receive approval to prescribe controlled substances. The verification server 112 may generate a one-time password for the user and communicate the password to a controlled communication channel associated with the user (e.g., send an email to an associated email address, send a text message to an associated mobile device, perform an automated voice call to an associated telephone number, etc.). In this example, the verification server 112 generates identification data (block 320) and communicates the identification data to the user via a controlled communication channel associated with the user (block 322).

In this example, identification data is illustrated as being communicated to the same user device 102. However, the embodiments of invention are not so limited. In some embodiments, the user may interact with the application server 110 with a first user device 102 (e.g., a personal computer) and the identification data may be communicated from the verification server 112 to a second user device 104, 106 (e.g., a cellular telephone, a smart phone, a tablet computer) different from the first user device 102. In some embodiments, the identification data may be communicated to a communication channel accessible with only a second user device 104, 106; for example, the user may receive a text message at a cellular phone number associated with the second user device 104, 106.

The user device 102 receives identification data as user input data (block 324), and the user device 102 communicates the identification data to the application server 110 and/or the verification server 112 (block 326). The verification server 112 processes the received identification data (block 328) to verify the identity of the user and authenticate the credentials of the user to prescribe controlled substances. In this example, the verification server 112 compares the received identification data (i.e., block 326) with the transmitted identification data (i.e., block 322). Following processing of the identification data, the verification server 112 communicates verification data to the application server 110, where the verification data indicates whether the user's identity was verified (block 330). In response to the received verification data indicating that the user's identity was verified, the application server 110 communicates the prescription data to the verification server 112 (block 332), and the verification server 112 includes signature data associated with the verified user in the prescription data (block 334). The signed prescription data is communicated to the application server 110 (block 336) and is then processed for communication to the pharmacy server 114 to fill the prescription.

With reference to FIG. 4 and in accordance with an embodiment of the invention a routine 350 illustrates a sequence of operations that may be performed by the user device 102, the application server 110 and the verification server 112 of FIG. 1 to generate signed electronic prescription data for a particular medication to a particular patient. In this example, a user may generate prescription data using a first user device 102, and the user may sign the electronic prescription using a second user device 106 after receiving notification at the second user device 106 that a prescription is pending for signature from the application server 110 and/or the verification server 112. The first user device 102 receives log-in data from the user (block 352), and the first user device 102 communicates the log-in data to the application server 110 (block 354).

The application server 110 processes the log-in data and confirms whether or not the log-in data is valid (block 356) based on data of a user record 164 stored in a user database 150 accessible by the application server 110. The application server 110 generates application data (block 357), and communicates the application data to the first user device 102 (block 358). The first user device 102 is configured to output the received application data for the user such that the user may make selections and/or input data corresponding to the prescription. As discussed previously, the application server 110 may generate the application data based on the user record 164 associated with the user associated with the log-in data, where the user record 164 may be stored in the user database 150 accessible by the application server 110. For example, the application server 110 may generate application data including one or more healthcare facilities associated with the user, one or more patients associated with the user, and/or other such information. Additionally, the output application data may include search functions that the user may utilize to search for and select a particular facility and/or patient.

The user inputs prescription information, and the user device 102 receives the input prescription information (block 360). In some embodiments, the output application data may present the user with a list of facilities associated with the user, and the user may select a facility from the list. Following selection of the facility the output application data may update to present the user with a patient search field and/or a list of patients associated with the user located at the selected facility, and the user may select the particular patient from the list or after searching. In some embodiments, the output application data may present the user with a list of facilities and patients associated with the facilities and user simultaneously, where the patients may be categorized by facility, and the user may select a particular patient from the output application data.

The output application data from the application server 110 may present the user with one or more prescription data fields that the user may input data for the particular medication. Prescription data including the prescription data fields, the selected patient, and/or other relevant information and a signing request indicating that the user will sign the electronic prescription with the second user device 106 may be communicated to the application server 110 (block 362). The application server 110 processes the received prescription data (block 364) to generate an electronic prescription, and the application server 110 communicates the electronic prescription and signing request data to the verification server 112 indicating that the user will sign the electronic prescription using the second user device 106 (block 366). In addition, the signing request data may include data indicating a communication channel to which a pending prescription notification may be communicated (e.g., an email address, a voice call to a telephone number, a text message to a mobile device, etc.). In this example, the signing request includes data indicating that the notification should be transmitted to the second user device 106.

The verification server 112 processes the electronic prescription and the signing request data (block 368) to determine that the user will sign the electronic prescription with the second user device 106, and the verification server 112 communicates the pending prescription notification to the second user device 106 (block 370). The pending prescription notification is output on the second user device 106, and the second user device 106 receives log-in data input by the user (block 372). The log-in data is communicated to the application server 110 (block 374), and the application server 110 processes the log-in data to confirm that the user is authorized to interface with the application server 110 (block 376). The application server 110 generates application data based on the log-in data (block 378). In this particular example, the user is logging in to sign an electronic prescription previously input by the user with the first user device 102. The application data generated by the application server 110 includes data for electronic prescriptions pending for the user's signature, where the application server 110 may identify pending electronic prescriptions for the user based on a user record 164 associated with the user stored in a user database 150 accessible by the application server 110.

The second user device 106 receives user input data selecting the prescription generated by the user using the first user device 102 for signing (block 382). The selection data is communicated to the application server 110 and/or the verification server (block 384). The verification server generates identification data (block 386) for communication to a communication channel controlled by the user. In this example, the verification server 112 communicates the identification data to the second user device 106 (block 390). The verification server 112 may communicate the identification data to the second user device 106 through a variety of communication channels previously discussed (e.g., text message, email, voice call); in addition, the second user device 106 may receive the identification data from application data output at the second user device 106. For example, the second user device 106 may execute an application 126 for interfacing with the application server 110 and/or the verification server 112, and after inputting log-in data, the identification data may be communicated through the interfacing application 126 either directly from the verification server 112 or indirectly from the application server 110.

The second user device 106 receives the identification data as user input data (block 392), and the second user device 106 transmits the identification data to the verification server 112 (block 394). The verification server 112 processes the received identification data to confirm that the received identification data matches the generated identification data (block 396). In response to confirming the identity of the second user, the verification server 112 includes signature data in the electronic prescription to generate a signed electronic prescription (block 398) and communicates the signed prescription to the application server (block 400).

While the example routines 300, 350 of FIGS. 3 and 4 illustrate a user generating and signing an electronic prescription, the invention is not so limited. In some embodiments, laws/regulations may prohibit agents (e.g., a nurse, a physician's assistant, etc.) associated with a user (e.g., a physician or other individual permitted to sign electronic prescriptions) from generating an electronic prescription for signature by the user, and in these embodiments, the routines performed may generally be similar to those shown in FIGS. 3 and 4. However, in some embodiments, an agent may be permitted to perform data input associated with an electronic prescription, and the user may be notified of electronic prescriptions pending for signature and sign such electronic prescriptions similar to blocks 370-400 of FIG. 4. Embodiments of the invention may allow an agent to perform data input operations to generate an electronic prescription based on one or more prescription rules 170, a user record 164, a facility record 166, and/or a medication record 162. For example, in a particular state, an agent of a user may be able to perform data input operations for non-controlled prescription medications, and in this example, the application server may interface with a user device 102 to allow the agent to perform data input operations (i.e., input data for one or more prescription data fields) while limiting the types of medication the agent may select to non-controlled prescription medications and/or over the counter medications. After providing the relevant prescription data, the agent may submit the electronic prescription, and the user may be notified of the pending electronic prescription, review the pending electronic prescription, and sign the electronic prescription.

Systems and methods consistent with one or more embodiments of the invention may be implemented in geographic regions having different laws and regulations related to the electronic prescribing of medications. For example, a physician may have patients located in different states, and as such, the laws/regulations may be different for each patient. In some embodiments of the invention, a rules database 156 stores a prescription rule 170 associated with each geographic region in which such embodiments may be utilized. Based on a user's selection of a patient and/or facility, some embodiments of the invention may identify the appropriate prescription rule(s) 170 and an application server 110 of in these embodiments may generate application data based on the identified prescription rule(s) 170 for interfacing with the user.

As described above with respect to flowcharts 300 and 350 of FIGS. 3 and 4, the user authorized to sign an electronic prescription may be required to input identification data (blocks 324, 392), where the required identification data may comprise two data fields. A first data field may correspond to identification data associated with the application server 110, including for example a log-in password (i.e., a knowledge factor) stored in the user record 164 associated with the user that the user utilizes to log-in to the application server 110. A second data field may correspond to identification data associated with the verification server 112, including for example the identification data communicated by the verification server 112 to a controlled communication channel of the user (blocks 322, 390). This second factor of identification data is stored separately from the application server 110. Therefore, the application server 110 and the verification server 112 may process identification data to verify the identity of the user, which may be referred to as two-factor authentication. To the user interfacing with the application server 110 and the verification server 112 using the user device 102, the two-factor authentication is transparent; i.e., the user device 102 prompts the user for input of both data fields, and the user device 102 communicates each data field to the appropriate server 110, 112. Alternatively, the second factor may be constituted by a different type of hard token or biometric information. Utilization of the two-factor credential constitutes the legal signature of the user, who may be a DEA-registered prescribing practitioner. Embodiments of the invention may implement two-factor authentication by requiring a user to provide two of the following: (a) a knowledge based factor (e.g., a password, a pin number, answer to a question, etc.); (b) a token based factor (e.g., a keycard, a controlled communication channel, etc.); and/or a physical characteristic token (e.g., a fingerprint, a retina, etc.). Moreover, while in the example embodiment, a first factor is analyzed at the application server 110 and a second factor is analyzed at the verification server 112, some embodiments of the invention may analyze and verify both factors at one server 110, 112.

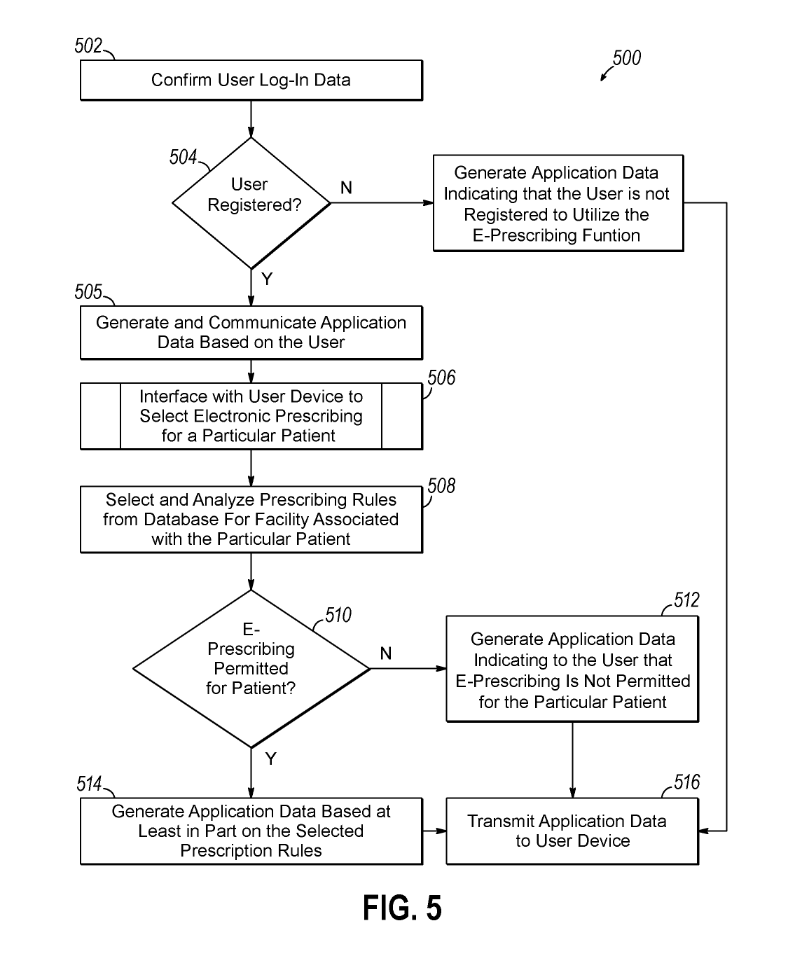

FIG. 5 provides a flowchart 500 that provides a sequence of operations that may be performed by the application server 110 consistent with some embodiments of the invention to identify applicable prescription rule(s) 170, and the interface between the application server 110 and user device 102 is based at least in part on the identified prescription rule(s) 170.

User log-in data is received and confirmed by the application server 110 (block 502). The application server 110 generates application data based on the user associated with the user log-in data (block 504). Specifically, the application server 110 determines whether the user indicated by the user log-in data is registered to access the application 144 and, based optionally upon the entry of additional credentials, is registered to electronically prescribe medications (block 504).

In response to determining that the user is not registered to electronically prescribe medications (“N” branch of block 504), the application server 110 generates application data indicating that the user is not registered to electronically prescribe medications (block 506). In response to determining that the user is registered to electronically prescribe medications (“Y” branch of block 504), the application server 110 generates and communicates application data based on the user identified by the log-in data to a user device (block 506). For example, based on the user identified by the user-log in data, the application server 110 may include facilities associated with the user and/or patients associated with the user in the application data. In some embodiments, the application server 110 may query a user database 150 to determine one or more facilities and/or patients associated with the user.

The application server 110 interfaces with the user device, and user input data indicates that the user wishes to electronically prescribe a medication to a particular patient (block 506). In response to receiving and processing user input data at the application server 110 indicating that the user wishes to electronically prescribe a medication to the particular patient, the application server 110 selects and analyzes one or more prescription rules 170 from among a plurality of prescription rules 170 stored in the accessible rules database 156 based on the facility associated with the particular patient (block 508). For example, the application server 110 may analyze a patient record 168 associated with the particular patient stored in an accessible patient database 154 to determine the facility associated with the patient, and the application server 110 may analyze a facility record 166 associated with the determined facility to determine a geographic region and/or a type of facility associated with the facility. In this example, the application server 110 may select and analyze the one or more prescription rules 170 based at least in part on the geographic region and/or the type of facility associated with the patient's facility.

The application server 110 determines whether electronic prescribing of medications is permitted for the particular patient based on the one or more selected prescription rules 170 (block 510). In response to determining that electronic prescribing is not permitted for the particular patient (“N” branch of block 510), the application server 110 generates application data indicating that electronic prescribing is not permitted for the particular patient (block 512). In response to determining that electronic prescribing is permitted for the particular patient (“Y” branch of block 510), the application server 110 generates application data based at least in part on the selected one or more prescription rules 170 (block 514). For example, if the one or more selected prescription rules 170 indicate that electronic prescribing is prohibited for one or more specific schedules of controlled substances (e.g., Schedule II Controlled Substances), the application data would include data limiting the user's ability to select medications of the prohibited schedule or schedules for electronic prescribing. The generated application data is communicated to the user device (block 516).

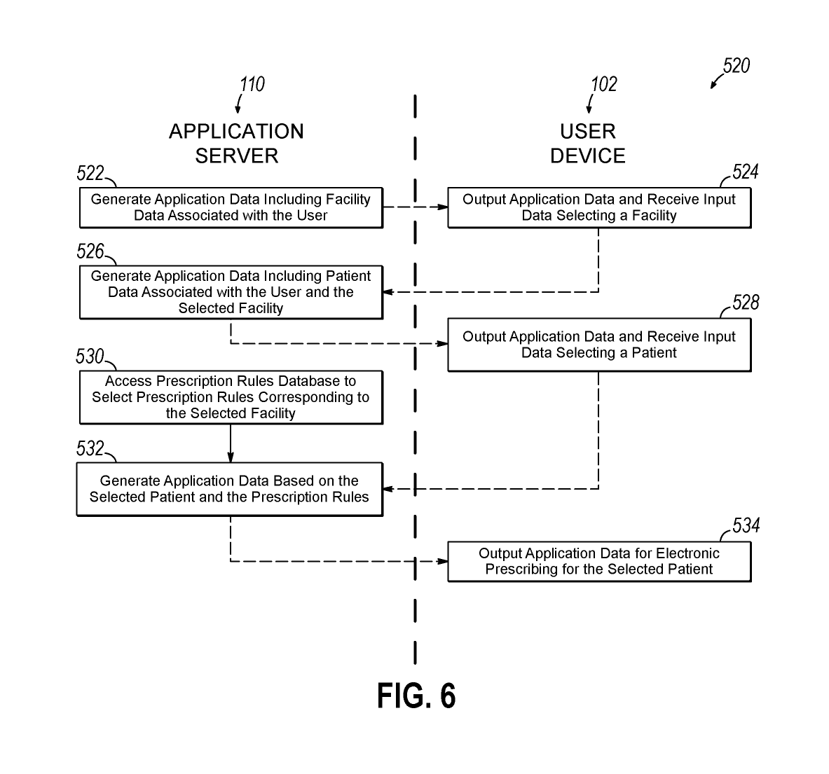

FIG. 6 provides a flowchart 520, which illustrates a sequence of operations that may be performed by a user device 102 and an application server 110 consistent with embodiments of the invention to interface therebetween to select a particular patient and generate application data for electronic prescribing for the particular patient. In flowchart 520, data is communicated between the application server 110 and the user device 102 and is illustrated by dashed arrows therebetween. The application server 110 generates application data including facility data associated with the user of the user device 102 (block 522). The application data is output at the user device 102, and the user device 102 receives user input data selecting a facility (block 524). The application server 110 generates application data based on the selected facility including patient data associated with the user and the selected facility (block 526).

Application data is output by the user device 102 including a list of patients associated with the user and the selected facility, and the user device 102 receives user input data selecting a particular patient (block 528). The application server 110 accesses a prescription rules database 156 to select one or more prescription rules 170 corresponding to the selected facility (block 530). The application server 110 generates application data based on the selected patient and the selected one or more prescription rules 170 (block 532). The user device 102 outputs the application data which provides an interface for generating an electronic prescription for the selected patient (block 534). The interface provided by the output application data is based at least in part on the selected one or more prescription rules 170 and the selected patient. For example, the application data may limit medications available for selection by the user based on the selected one or more prescription rules 170; in addition, the application data may include patient data associated with the selected patient, including for example the patient's name, already prescribed medications for the patient, the address of the patient, and/or other such information.

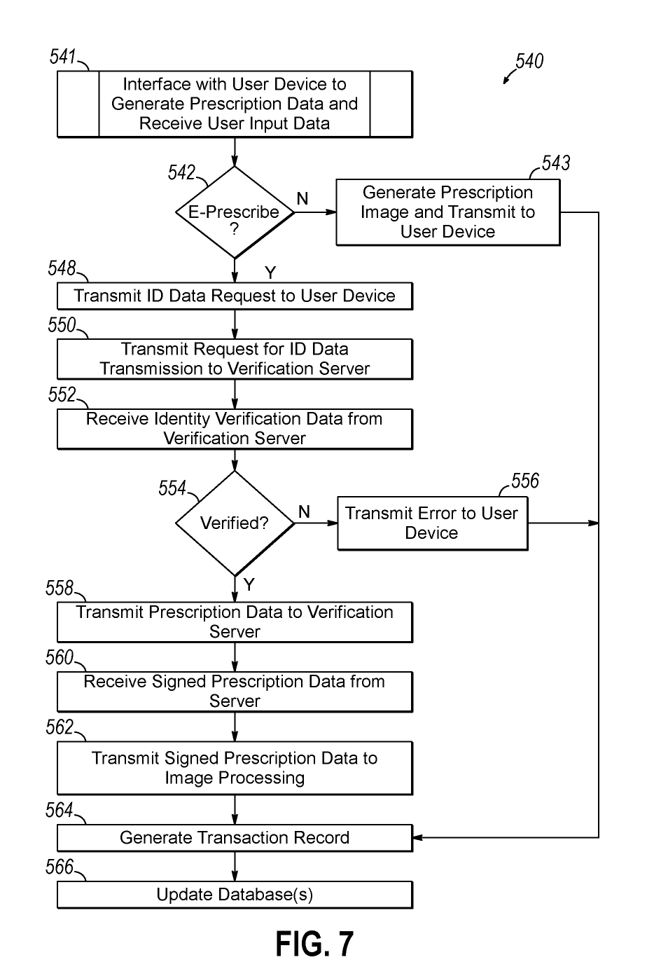

FIG. 7 provides a flowchart 540 that illustrates a sequence of operations that may be performed by an application server 110 consistent with some embodiments of the invention to communicate an electronic prescription electronically signed by a verified user to a pharmacy server 114. The application server 110 interfaces with a user device to generate prescription data indicating a medication for an electronic prescription and/or receive user input data associated with the prescription data (block 541). The application server 110 analyzes the user input data associated with the prescription data to determine whether the user desires to electronically prescribe a prescription corresponding to the prescription data (block 542). In response to determining that the user does not desire to electronically prescribe the prescription (“N” branch of block 542), the application server 110 generates a prescription image 174 based on the prescription data and transmits the prescription image 174 to the user device (block 543) such that the user may print the prescription image 174 for a paper prescription. In response to determining that the user desires to electronically prescribe the prescription (“Y” branch of block 542), the application server 110 communicates a request for identification data to the user device (block 548). In this example, the application server 110 also communicates a request to a verification server 112 to transmit identification data to a communication channel associated with the user (block 550). The application server 110 receives verification data from the verification server 112 (block 552), where the verification data includes data indicating whether the identity of the user is verified. The application server 110 analyzes the verification data to determine whether the identity of the user is verified (block 554). In response to determining that the user's identity is not verified (“N” branch of block 554), the application server 110 may communicate application data to the user device 102 indicating that the user's identity has not been verified (block 556). In response to determining that the user's identity is verified, the application server 110 communicates the prescription data to the verification server 112 (block 558), and the application server 110 receives signed prescription data from the verification server 112 (block 560).

The signed prescription data is communicated to a computing device configured to perform image processing to generate a prescription image 174 based on the signed prescription data (block 562). In some embodiments, the application server 110 may include an image processing computing device, as such in these embodiments, the signed prescription data may be transmitted to a processor of the application server 110 executing program code which causes the processor to generate a prescription image 174 based on signed prescription data. In some embodiments, the image processing computing device may be located remotely and/or logically separated from the application server 110 such that the application server 110 may be required to transmit the prescription data over a communication network to the image processing computing device. In this example, the application server 110 generates a transaction record 172 for a transaction, including generated electronic prescriptions, failed electronic prescriptions, and/or generated paper prescriptions (block 564). The transaction record 172 may include information related to the transaction, including for example, the user, the patient, the facility, the date and time, the prescription data, and/or other such information. The application server 110 updates one or more accessible databases 150, 154, 158 (block 566). A transaction database 158 associated with the application server 110 may be updated with the generated transaction record 172. In addition, a user record 164 of a user database 150 associated with the user may be updated based on the transaction, and/or a patient record 168 of a patient database 154 associated with the patient may be updated based on the transaction.

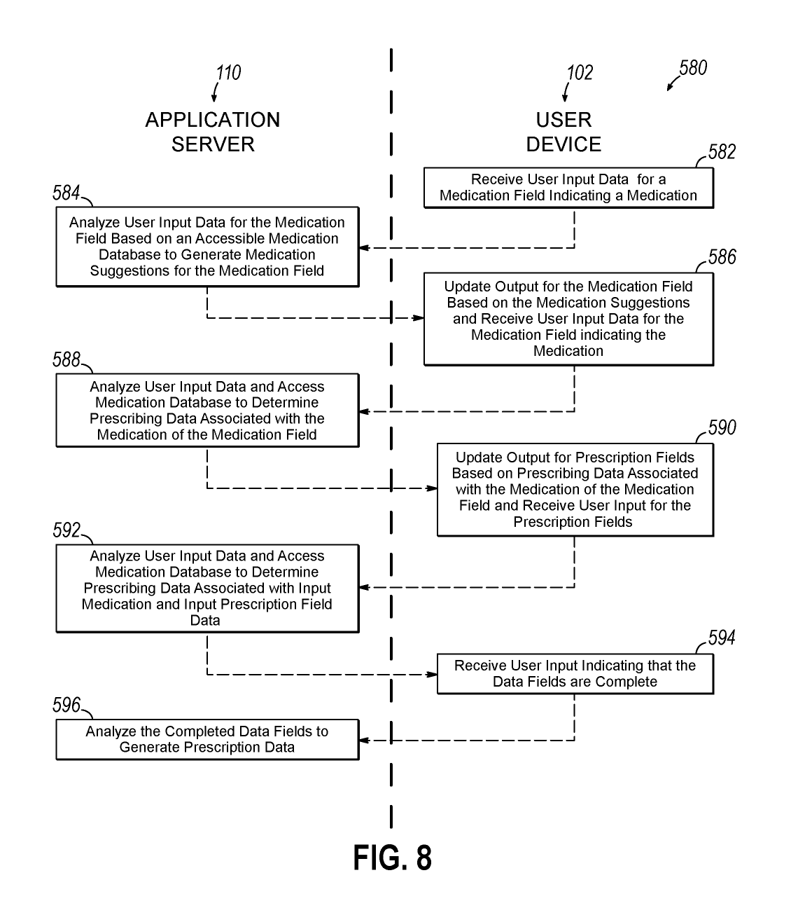

FIG. 8 provides a flowchart 580 illustrating a sequence of operations that may be performed by an application server 110 and a user device 102 consistent with embodiments of the invention to interface therebetween to generate prescription data including one or more prescription data fields for a particular patient. Prescription data fields may include for example, the medication name (“medication field), a dose quantity field, a dose route field, a dose frequency field, a prescribed quantity field, a prescription refill field, and/or a diagnosis field. In addition, other data fields may be included, such as a data field indicating whether a generic substitute is acceptable. In this example, the application server 110 and user device 102 communicate data therebetween, and such communication is indicated by dashed arrows in the flowchart 580. Furthermore, each dashed arrow does not necessarily represent only a single transmission and receipt of data, but may represent a plurality of communications. As the communication components and methods which may be utilized in some embodiments of the invention may utilize a substantially continuous communication of data between a user device, application server 110 and/or verification server 112, such that input data received at a user device 102 may be communicated to the application server 110 in portions, and upon receipt such application data may be updated by the application server 110 responsive to such input data portion and communicated to the user device 102 to update the output of application data. For example, if a user input a first letter of a medication name into a user device 102, the first letter may be communicated to the application server 110 and application data may be communicated to the user device 102 based on the first letter to update the output displayed on the user device 102.

The user device 102 receives user input data for a medication data field for the prescription data (block 582). The application server 110 analyzes the user input data for the medication field and generates updated application data including medication suggestions for the medication field based on the user input data (block 584). The application server 110 may access a medication database 148 including a plurality of medication records 162 and the medication suggestions for the medication field may be based on such medication records 162 of the medication database 148. For example, if user input data for the medication field includes a portion of a medication name, the application server 110 may search the medication database 148 to determine medications including the portion in the name of the medication, and the medication suggestions may include such determined medications.

The output of the application data is updated at the user device 102 based on the medication suggestions, and the user device receives further user input data indicating the medication (block 586). The process described in block 584 and 586 may be repeated until the user input data indicates that data entry for the medication field is completed and/or the application server 110 determines that the data of the medication field corresponds to a medication that may be electronically prescribed based on prescription rules 170 and/or medication records 162. The application server 110 accesses the medication database 148 to determine prescribing data associated with the medication indicated in the medication field (block 588). Such prescribing data may include information related to one or more of the prescription fields.

The output application data for the prescription fields is updated at the user device 102 based on the prescribing data associated with the medication, and the user device 102 receives user input data for the prescription fields (block 590). The prescribing data may cause the output application data of the user device 102 to limit user input for one or more prescription fields. For example, the user may be prevented from inputting data into a data field for prescription refills based on the medication selected. As another example, the user may have limited options for a dose frequency field based on the medication selected. As the user device 102 receives input data for the prescription fields, the application server 110 analyzes the user input data for prescription fields to further update prescribing data based on the medication record 162 associated with the medication (block 592).

For example, if the medication field and dose route field include user input data, the updated prescribing data may include dose frequency data based on the medication field and the dose route field. As a particular example, if a user inputs an OTC medication, a ‘Quantity Required’ data field and/or a ‘Refills’ data field may be removed, as the user will not be required to specify such information for an OTC medication. In another example, a medication may be a liquid medication, and based on the prescribing data indicated in the medication record 162, the ‘Prescribed Quantity’ data field may be updated to require input of the ‘Prescribed Quantity’ to correspond to common formats for liquid medications. For example, a ‘Drug Name’ data field may include input data indicating eye drops. In this example, the ‘Prescribed Quantity’ field may be updated to require the input data to indicate the number of drops to be administered at a time, and in addition, a ‘Directions’ field may be added in the updated application data such that the user may input free-text for the directions (e.g., “one drop in right eye twice daily as needed for dryness”).

When a non-controlled prescription medication is input into the ‘Drug Name’ data field, the application server 110 may update the prescription data fields to reflect the information required by laws/regulations (as indicated in selected prescribing rules 170), the particular facility of the selected patient, and/or the remote pharmacy to electronically prescribe a non-controlled prescription medication. For example, in addition to a ‘Drug Name’ data field, a ‘Reason’ or ‘Diagnosis’ data field, a ‘Route’ data field and/or ‘Frequency’ may be required, while a ‘Prescribed Quantity’ and/or ‘Refills’ may not be required. Similarly, when a controlled substance medication is input into the ‘Drug Name’ data field, the application server 110 may update the prescription data fields to reflect the information required by laws/regulations, the particular facility and/or the remote pharmacy to electronically prescribe a controlled substance. For example, in addition to a ‘Drug Name’ field, a ‘Route’ data field, a ‘Frequency’ data field, a ‘Prescribed Quantity’ data field, a ‘Refills’ data field, an ‘Earliest Fill Date’ data field, and a ‘Diagnosis’ data field may be required.

In some embodiments, required data fields may be added, removed, and/or updated based on the data input into other prescription data fields and selected prescribing rules 170 during generation of an electronic prescription for a particular patient. Selecting prescribing rules 170 may be based on a facility associated with the particular patient, where such selecting may be based at least in part on the geographic region and facility type of the associated facility. For example, in a particular state, laws/regulations may differentiate between institutional facilities (e.g., long-term care facilities, skilled nursing facilities, etc.) and other types of facilities (e.g., assisted living facilities), as such, the prescription data fields presented to the user via the user device 102 may be different depending on the type of the associated facility as indicated in a facility record 166 corresponding to the associated facility. Continuing the example, a particular state may not require an electronic prescription for a patient of an institutional facility include data indicating a refill number or a quantity number for non-controlled prescription medications, but may require such information for an electronic prescription for patients of other types of facilities. In this example, depending on the type of facility in the particular state at which the patient is located, the output application data may not require a user to provide input data for a ‘Refill’ data field and/or a ‘Quantity’ data field, or the output application data may not present the user with a ‘Refill’ and/or ‘Quantity’ data fields.

The process described with respect to block 590 and 592 may be repeated until user input data indicates that the prescription data fields are complete and the prescription is ready for processing (block 594). The application server 110 analyzes the completed prescription fields and generates electronic prescription data for signing (block 596). Hence, embodiments of the invention that perform operations described with respect to flowchart 580 may provide a guided interface for a user to input data into prescription fields, where the application server 110 may analyze the user input data to generate suggested values for prescription fields to guide the user in filling out the required information for an electronic prescription.

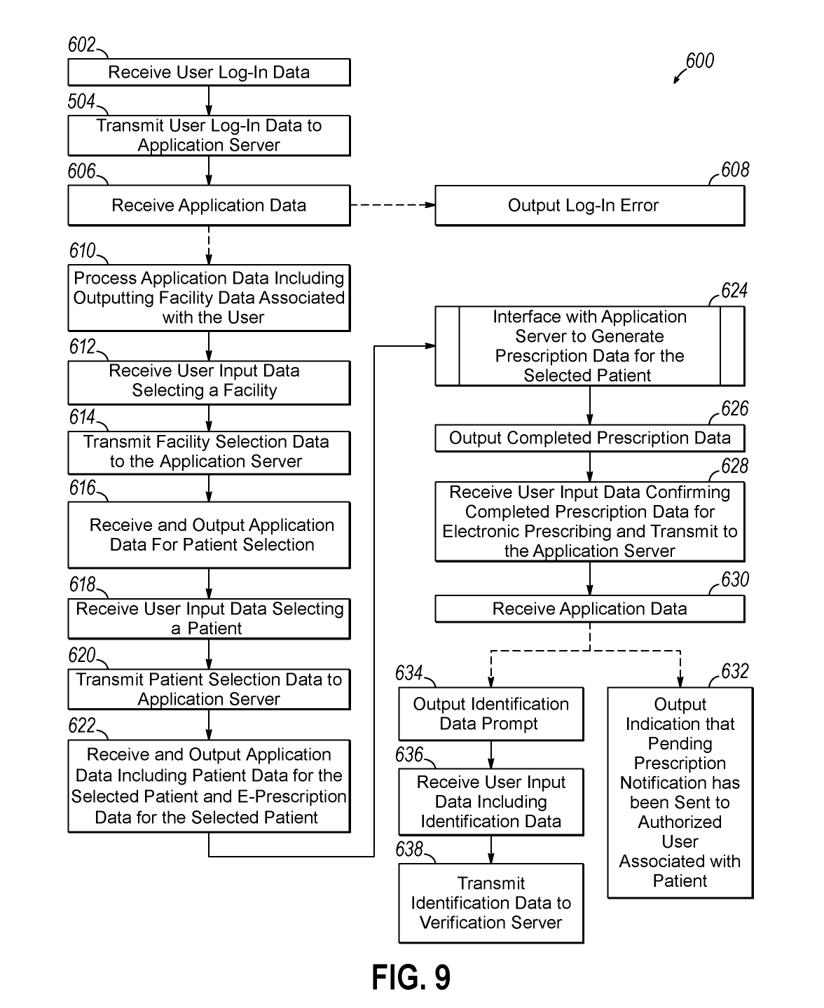

FIG. 9 provides a flowchart 600 illustrating a sequence of operations that may be performed by a user device consistent with some embodiments of the invention to electronically prescribe a medication to a particular patient by interfacing with an application server 110. The user device receives user log-in data (block 602), and the user device transmits the user log-in data to the application server 110 (block 604). The user device receives application data from the application server 110 (block 606). Based on whether the log-in data corresponds to a valid user, the received application data outputs a log-in error message at the user device (block 608), or the application data outputs facility data associated with the user (block 610). The user device receives user input data selecting a facility (block 612), and the user device communicates the facility selection data to the application server 110 (block 614).

The user device receives and outputs application data for selecting the particular patient (block 616). In some embodiments, the application data may include a search field such that the user may to input data into the search field at the user device and search for the particular patient. In these embodiments, the user input data of the search field may be communicated to the application server 110 and the results may be returned in application data output at the user device. The user device receives user input data selecting the particular patient (block 618), and the user device communicates the patient selection data to the application server 110 (block 620). The user device receives and outputs application data including patient data and electronic prescription data associated with the selected patient (block 622). The user device interfaces with the application server 110 to generate prescription data for the selected patient (block 624), and the completed prescription data is output at the user device for review by the user (block 626).

The user device 102 receives input data confirming that the prescription data is ready for electronic prescribing, and the user device 102 transmits confirmation data to the application server 110 (block 628). The user device 102 receives application data from the application server 110 (block 630). In some embodiments, a user may input prescription data while the user is not authorized to sign the electronic prescription. If the user is not authorized to sign the electronic prescription, the user device 102 outputs application data indicating that the electronic prescription is pending signature by an authorized user (block 632). If the user is authorized to sign an electronic prescription, the user device 102 outputs application data prompting the user to input identification data (block 624), and the user device 102 receives user input data including the identification data (block 626). The user device 102 transmits the identification to a verification server 112 (block 638).

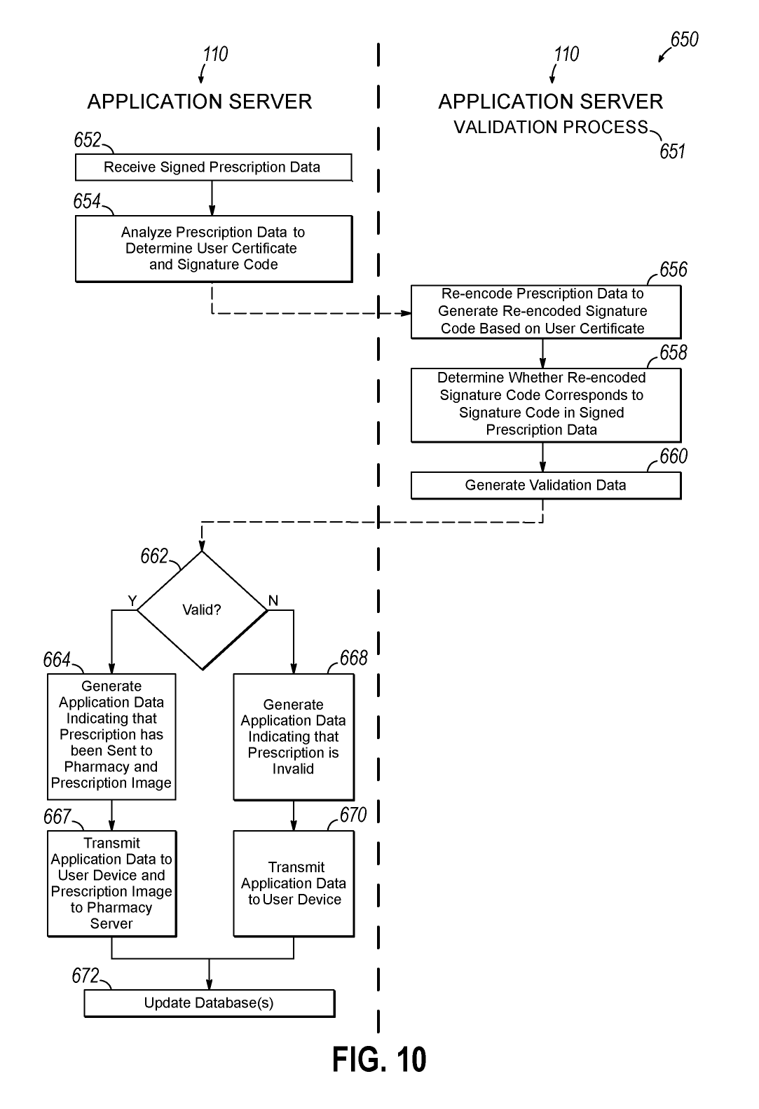

In some embodiments of the invention, after receiving signed prescription data a prescription image 174 may be generated for communication to the pharmacy server 114. Prior to generating the prescription image 174 or transmitting the prescription image 174, the signed prescription data may be analyzed to determine whether the signed prescription data is valid. In these embodiments, a validation process executing on the application server 110 and/or an image processing computing device logically separated from the application server 110 may analyze the signed prescription data prior to the prescription image being transmitted to a pharmacy server 114. FIG. 10 provides a flowchart 650 illustrating a sequence of operations that may be performed by an image processing device (in this example validation process 651 executing on application server 110) to analyze a prescription image 174 to determine the validity of the prescription image 174. In this example, the validation process 651 may be executing on the application server 110 separate from the electronic prescribing interface described herein (e.g., on different processors, memory, etc.). Therefore, data may be communicated from the application server 110 executing the electronic prescribing interface to the executing validation process 651, where such communication is illustrated by dashed arrows, where each dashed arrow may represent a single data communication or a plurality of data communications. The application server 110 receives signed prescription data (block 652). The application server 110 analyzes the signed prescription data to determine a user certificate and a signature code included in the signed prescription data (block 654). As discussed previously, the verification server 112 may include the signature code and user certificate in prescription data upon verification of the user's identity.

In some embodiments, the user certificate and/or the signature code may be indicated in the signed prescription data by machine readable indicia including for example, a barcode, a Quick Response (QR) code, and/or any other type of machine readable indicia, and in such embodiments, the application server 110 may scan such machine readable indicia to determine the user certificate and/or signature code. Furthermore, in some embodiments, the user certificate location and/or the signature code may be indicated on the prescription image by human readable characters (e.g., alphanumeric or text characters), and in such embodiments, the application server 110 may perform optical character recognition analysis to determine the user certificate and/or signature code.

The validation process 651 re-encodes the prescription data of the signed prescription and to generate a re-encoded signature code based on the user certificate (block 656). The validation process 651 determines whether the re-encoded signature code corresponds to the signature code in the signed prescription data (block 658). The validation process 651 generates validation data indicating whether the prescription is valid based on the determination of whether the re-encoded signature code corresponds to the signature code of the signed prescription data (block 660). The application server 110 analyzes the validation data to determine whether the signed prescription data is valid (block 662).

In response to determining that the signed prescription data is valid (“Y” branch of block 662), the application server 110 generates application data indicating that the prescription has been sent to an associated pharmacy and a prescription image of the signed prescription data (block 664), and the application server 110 transmits the application data to a user device 102 and the prescription image to a pharmacy server 114 (block 667). In response to determining that the prescription is invalid (“N” branch of block 662), the application server 110 generates application data indicating that the prescription is invalid (block 668) and transmits the application data to the user device 102 (block 670). The application server 110 may update one or more databases 150, 154, 158 based on the validity of the signed prescription data. For example, the application server 110 may update a transaction record 172 associated with the prescription image 174 to indicate whether the prescription image 174 was transmitted to the pharmacy. In another example, the application server 110 may update a user record 164 associated with the user issuing the prescription, and/or update a patient record 154 associated with the patient indicated on the prescription.

The application server 110, verification server 112, and user device 102 consistent with embodiments of the invention may interface to generate an electronic prescription. The interfacing may be performed utilizing one or more device interfacing processes. In some embodiments, the user device 102 may execute a particular application 126 configured to securely communicate and interface with the application server 110 and/or the verification server 112. In some embodiments, the user device 102 may interface with the application server 110 and/or verification server 114 utilizing an Internet browser such that the application server 110 may provide a secured web-based interface at a network location (e.g., an Internet address, a local network address, a wide area network address, etc.), and a user may navigate to the network location utilizing the user device 102 to interface and interact with the application server 110 via the web-based interface. In these embodiments, the user may be required to provide log-in data to the web-based interface prior to interfacing with the application server 110 to generate an electronic prescription. In some embodiments, an application 126 for interfacing or the web-based interface may provide a single interface for the user device 102 to interface with both the application server 110 and the verification server 112. In other embodiments, one or more applications 126 and/or web-based interfaces may be utilized to interface between the application server 110, verification server 112, and the user device 102.

Furthermore, in some embodiments of the invention, as described previously, the application server 110, the verification server 112, and/or the pharmacy server 114 may comprise a closed system for generating, transmitting and filling electronic prescriptions at a dedicated remote pharmacy for patients of facilities associated with the remote pharmacy. As opposed to conventional electronic prescription systems, where a user may electronically prescribe a medication to any patient using various pharmacies, in closed system embodiments of the invention, a user may be limited to electronically prescribing medications to patients in facilities associated with the remote pharmacy. In such closed system embodiments, a prescriber desiring to utilize the system may be required to register and provide relevant information and/or information required by law or regulation. After registration, the application server 110 provides a front end interface for the registered user to submit an electronic prescription to the remote pharmacy for patients of the associated facilities. In such closed system embodiments, the databases 148, 150, 152, 154, 156, 158, 188, 196, 200, 224 generally described with respect to the application server 110, verification server 112, and/or pharmacy server 114 may be commonly accessible by the application server 110, verification server 112, and/or pharmacy server 114. Closed system embodiments of the invention may limit a registered user's options when electronically prescribing medications based on patient data records 168, facility data records 166, medication data records 162, prescribing rules 170, and/or user data records 164. Guided interfacing with the remote pharmacy in embodiments of the invention includes the transparent application of one or more prescribing rules 170 during a registered user's interface with the application server 110. In conventional electronic prescribing systems, such data is not generally available to a pharmacy filling an electronic prescription, which may lead to diversion and/or modification of electronic prescriptions.

Moreover, as the application server 110 and pharmacy server 114 are commonly controlled in these embodiments the possibility of diversion and/or forgery may be reduced as compared to conventional electronic prescription systems. In that regard, an added level of security may be realized by such closed system embodiments based on the limited number of users that may utilize the system and the limited number of patients for which electronic prescriptions may be generated and filled, where such numbers are limited by the association between the remote pharmacy and the facilities, and the application server 110 and pharmacy server 114 may access database records 164, 166, 168 during generation and filling of such electronic prescriptions to thereby validate such electronic prescriptions. In such closed system embodiments, electronic prescriptions filled by the remote pharmacy may be delivered to the appropriate associated facilities, thereby reducing the possibility of diversion and/or forgery associated with patient pick-up of a filled prescription at a typical pharmacy.

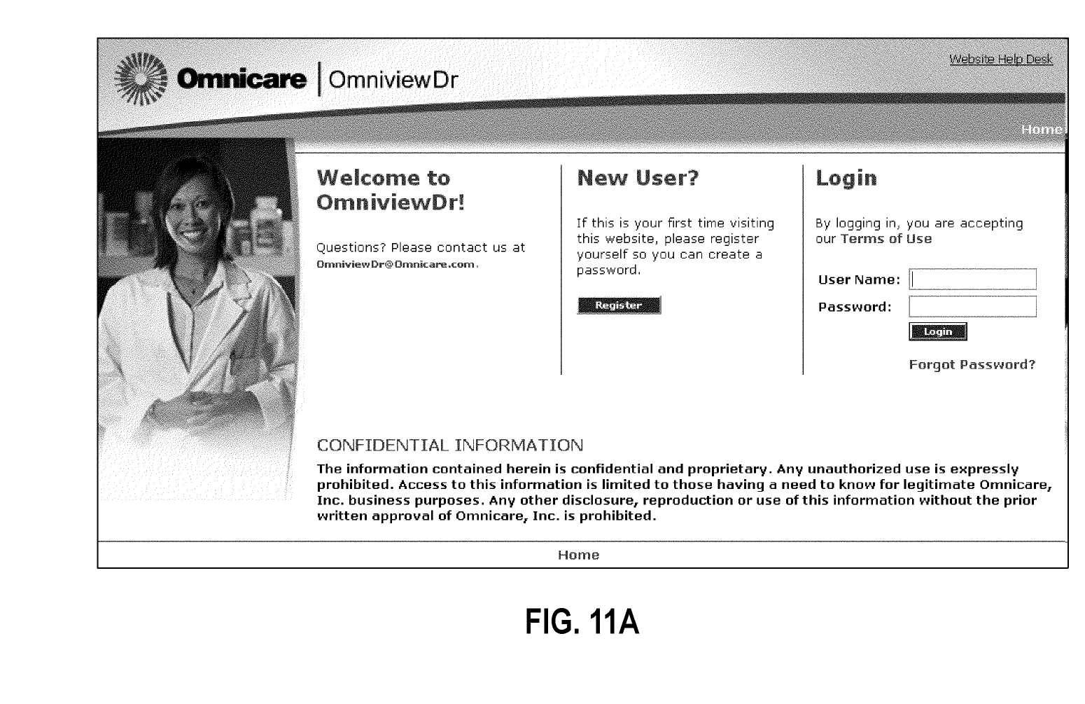

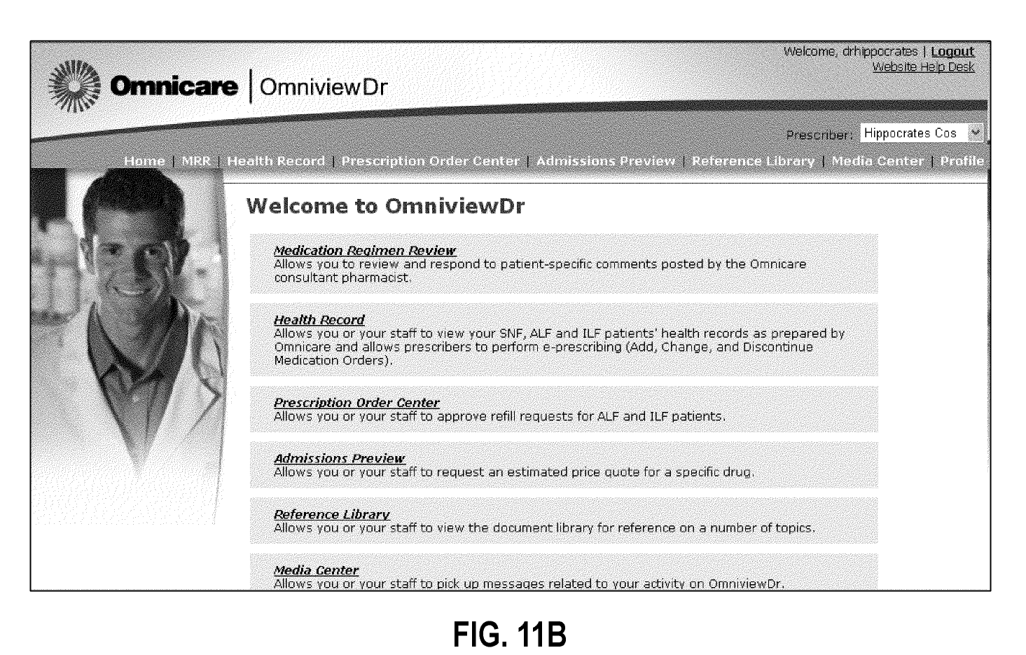

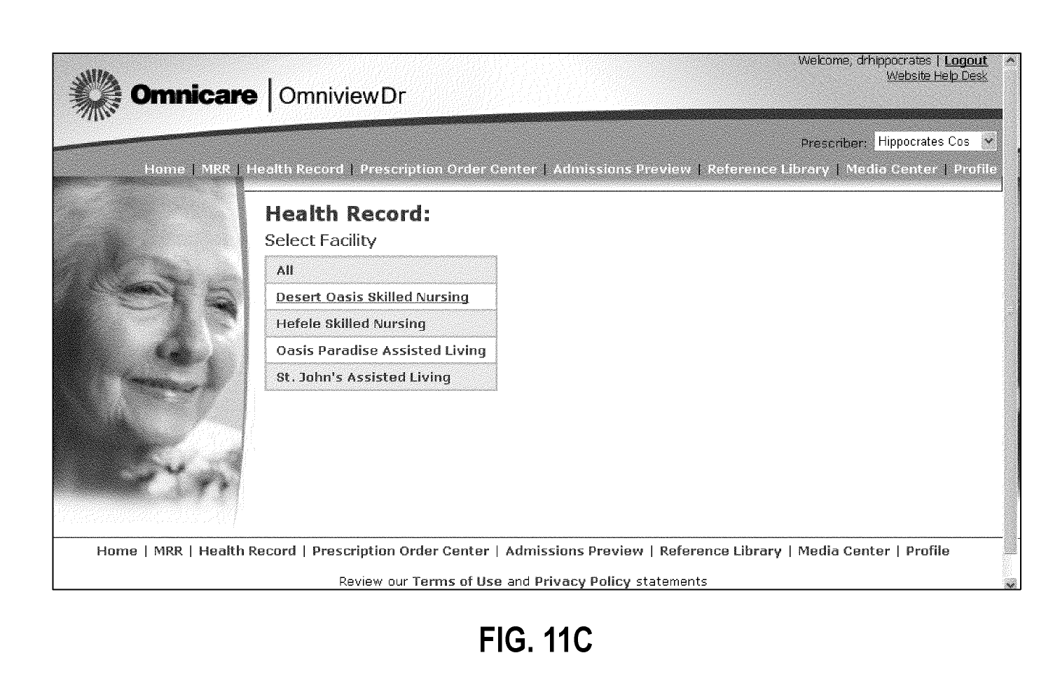

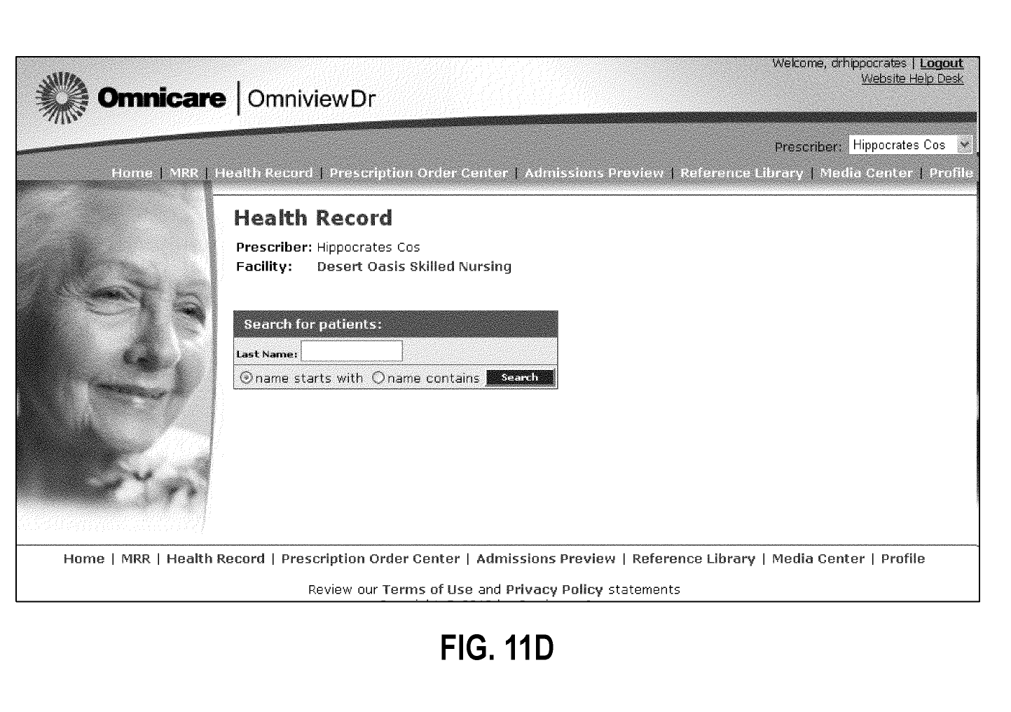

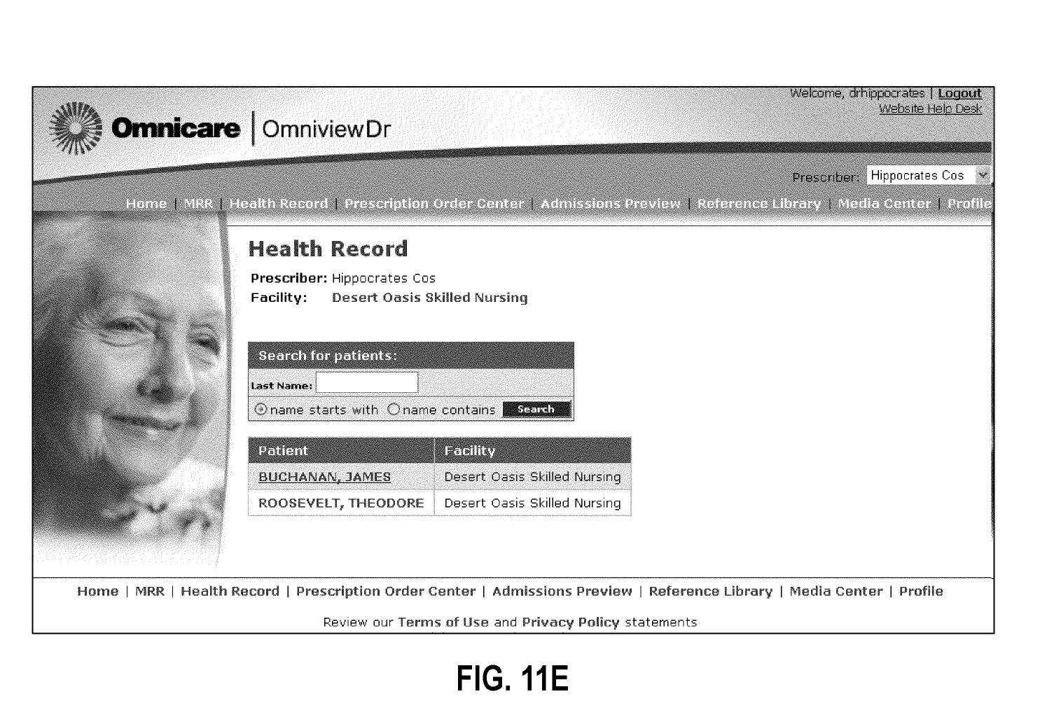

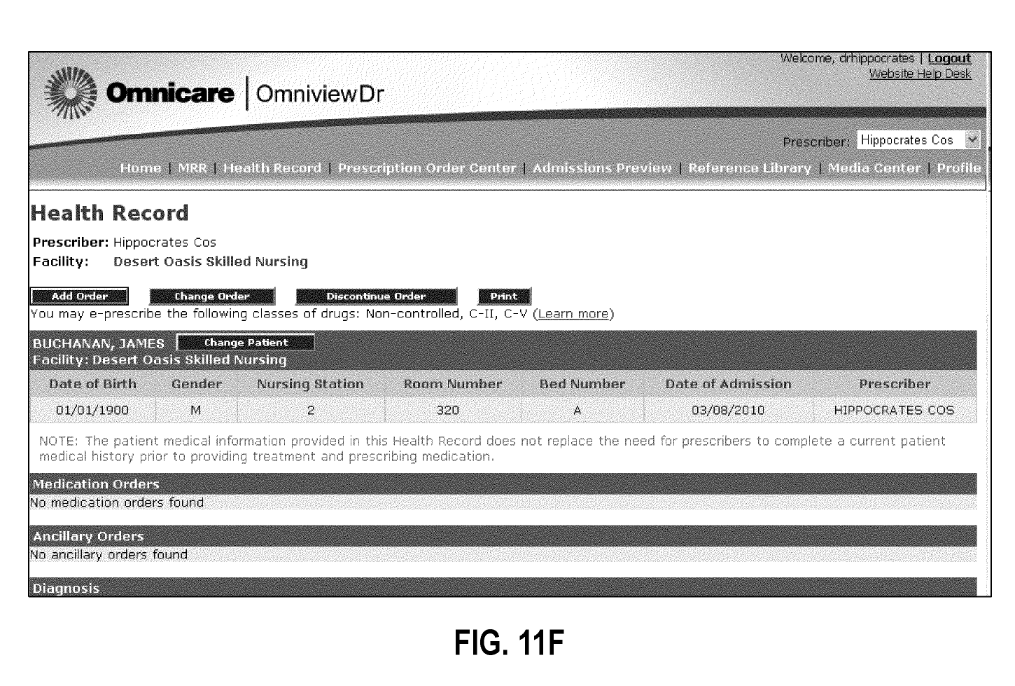

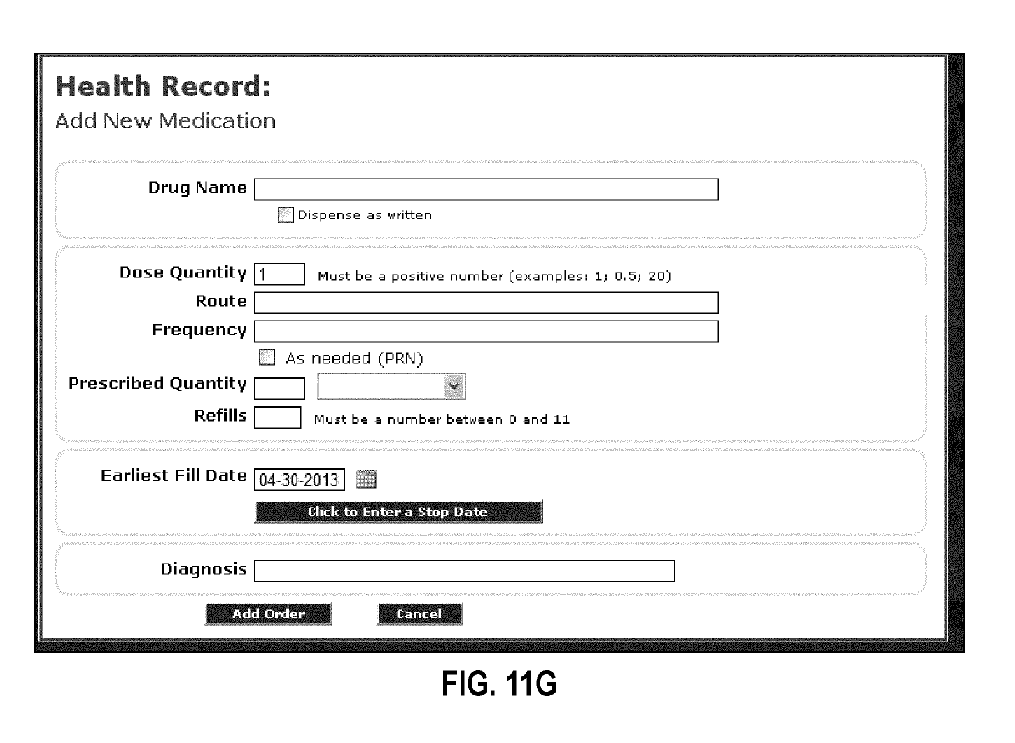

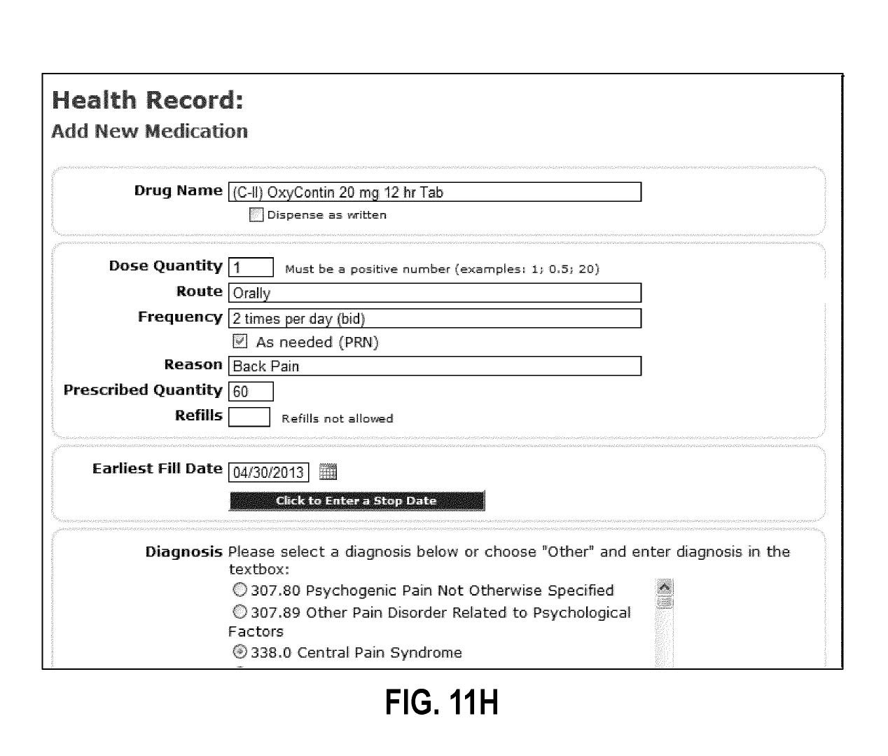

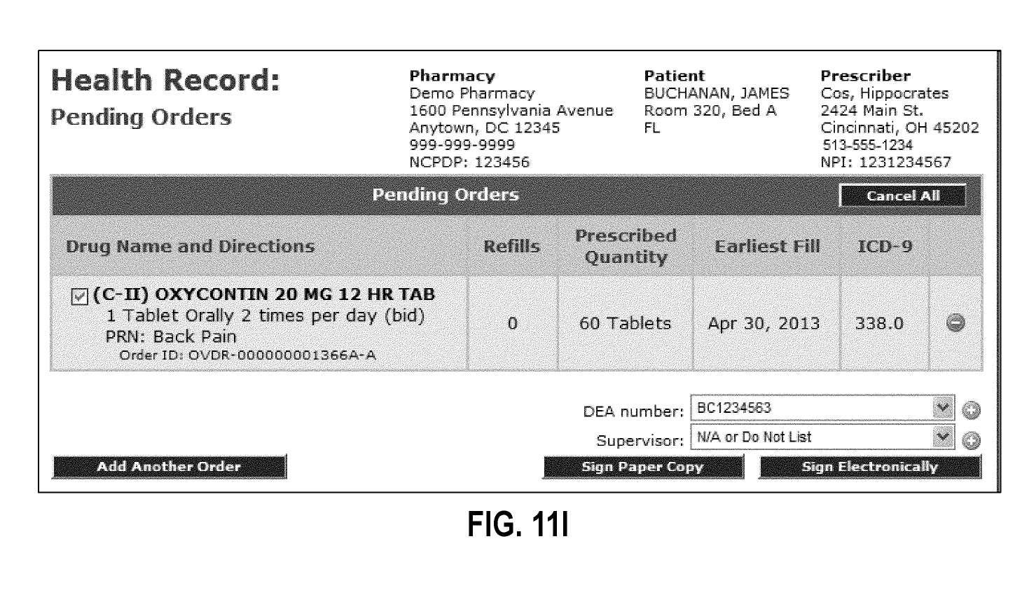

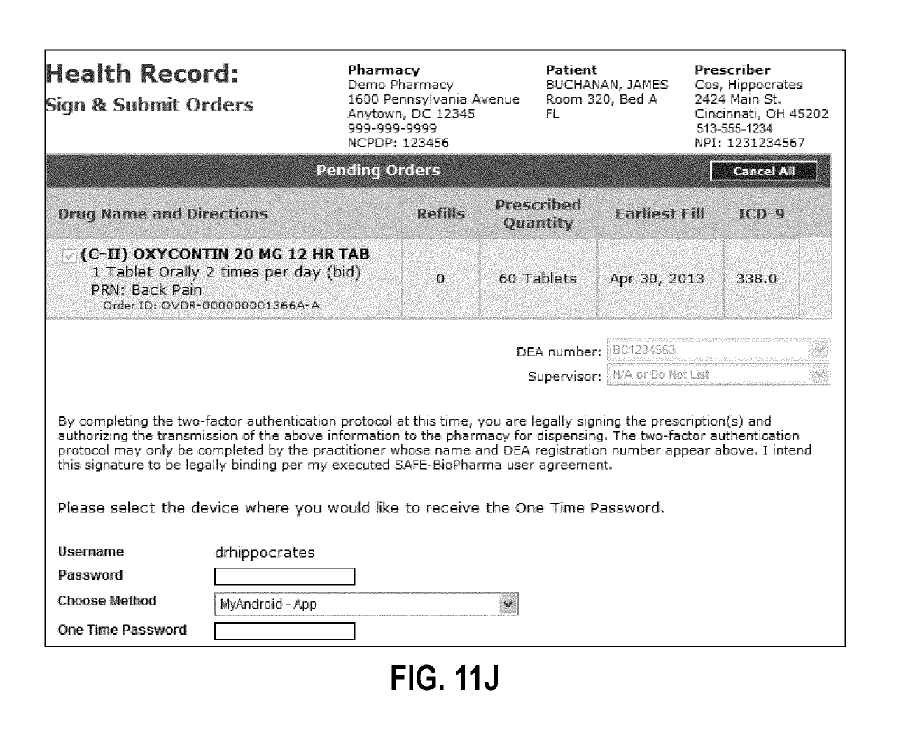

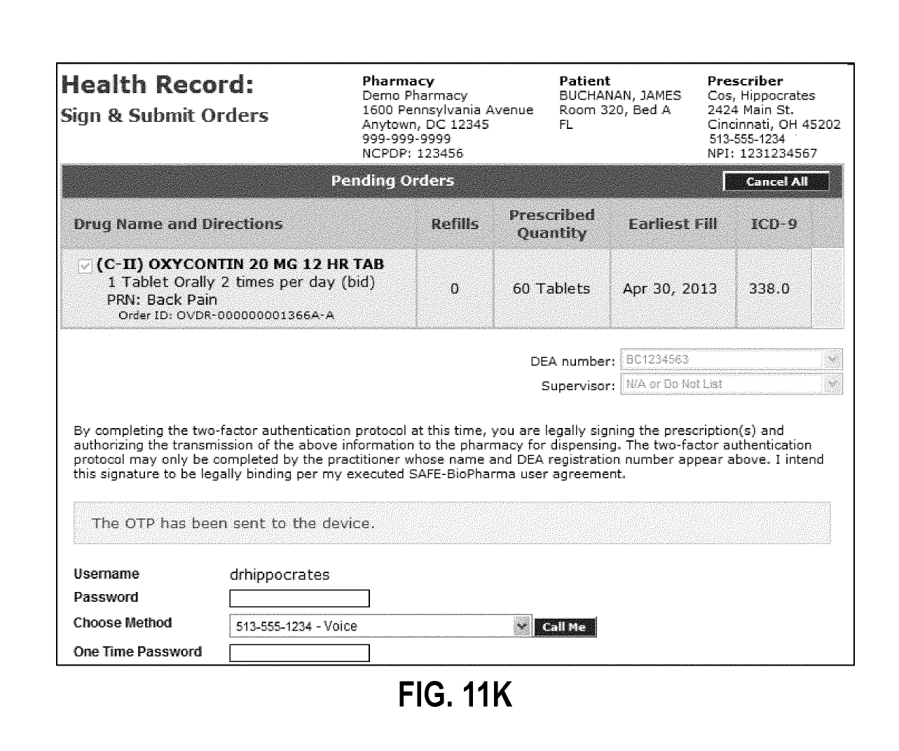

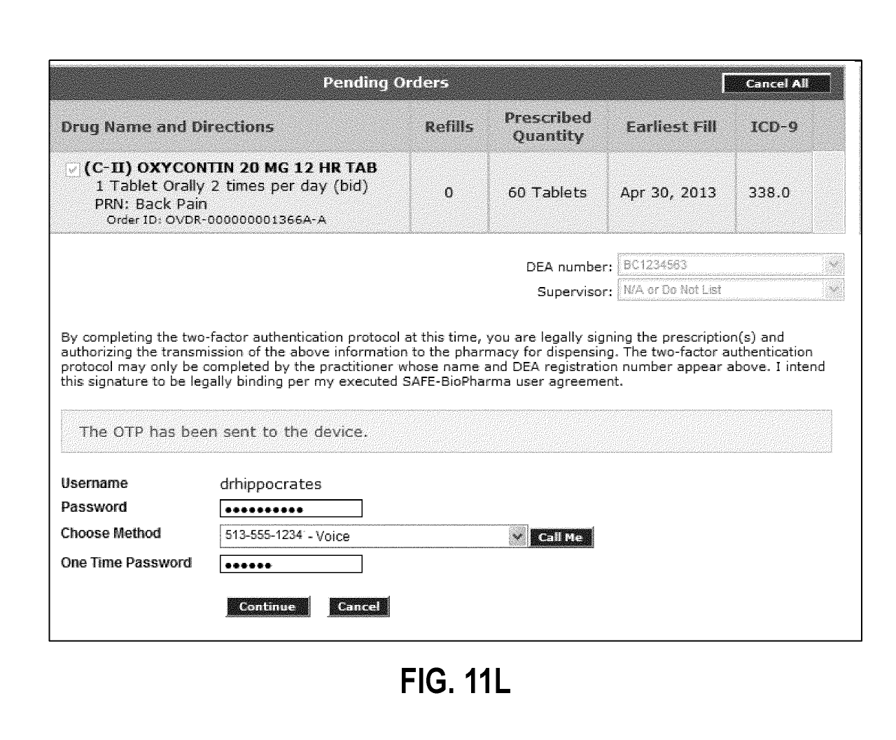

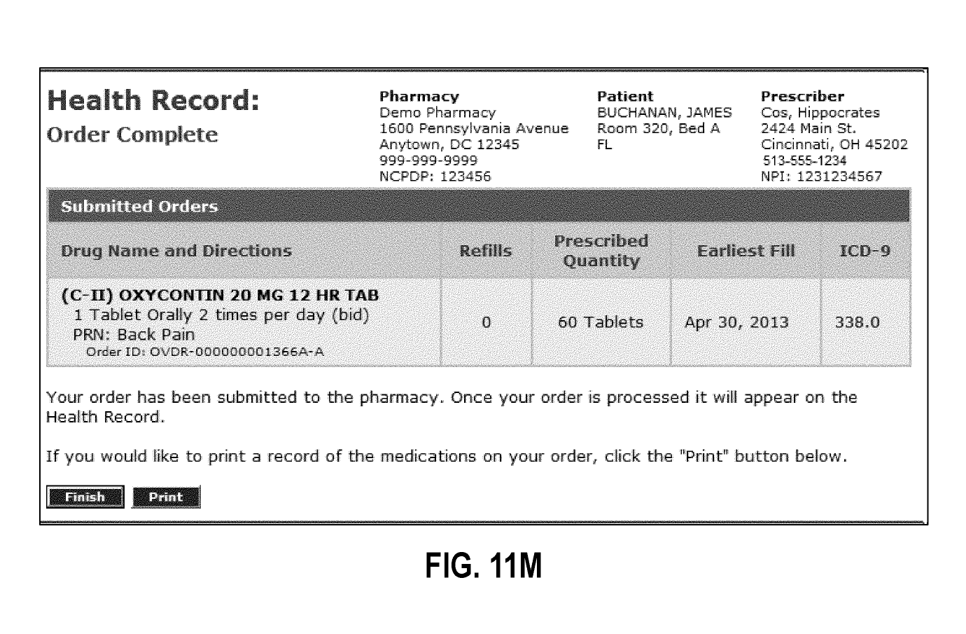

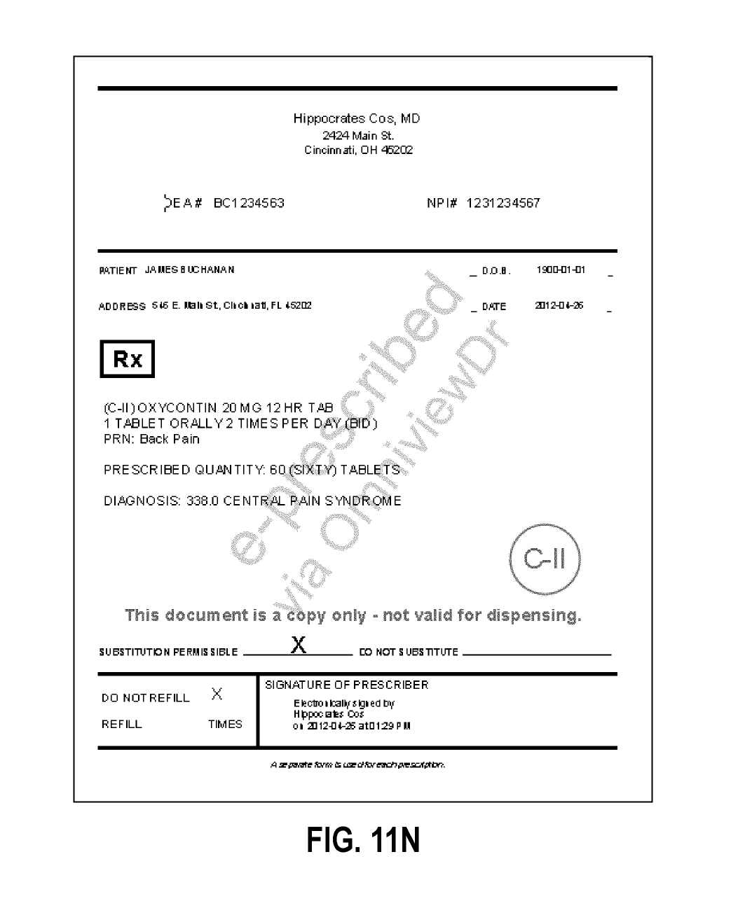

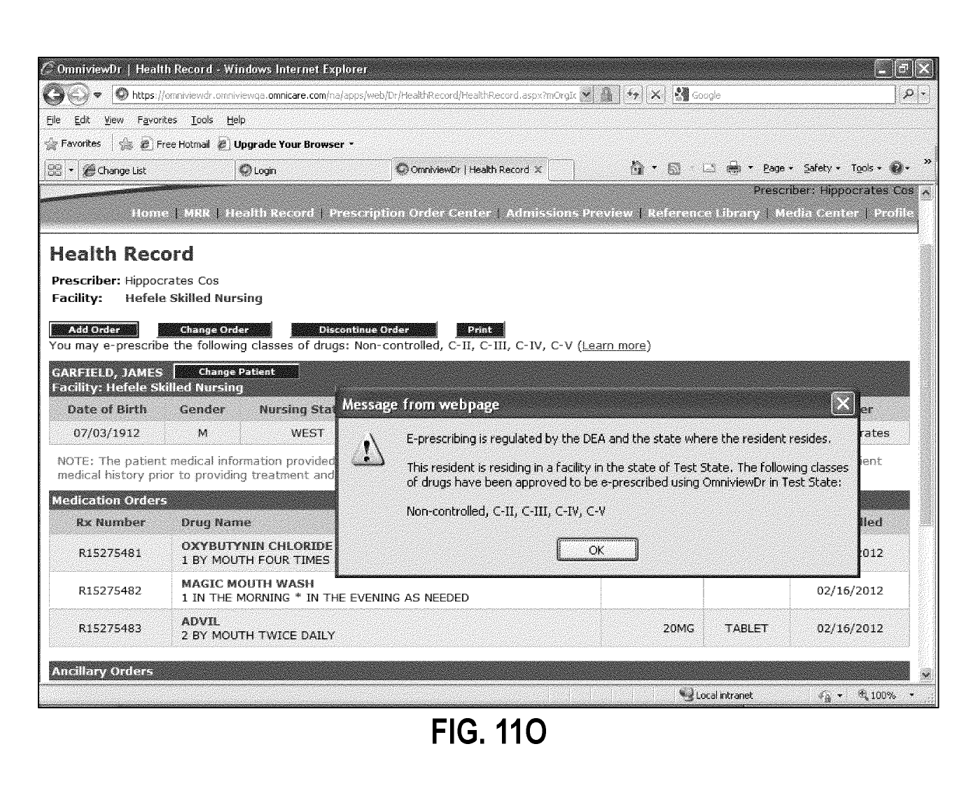

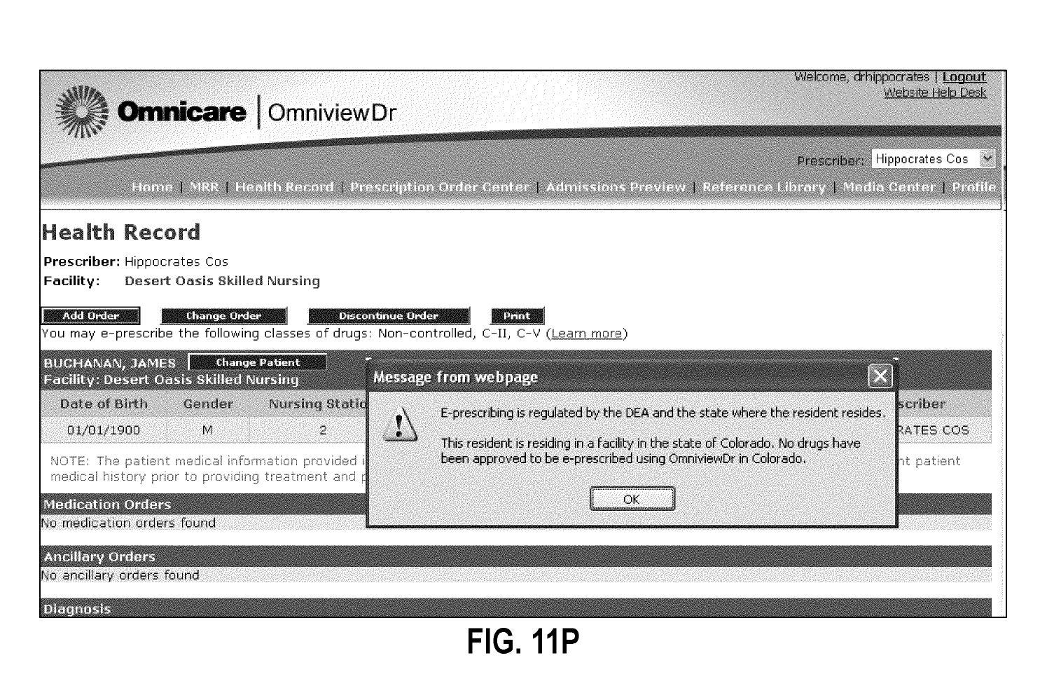

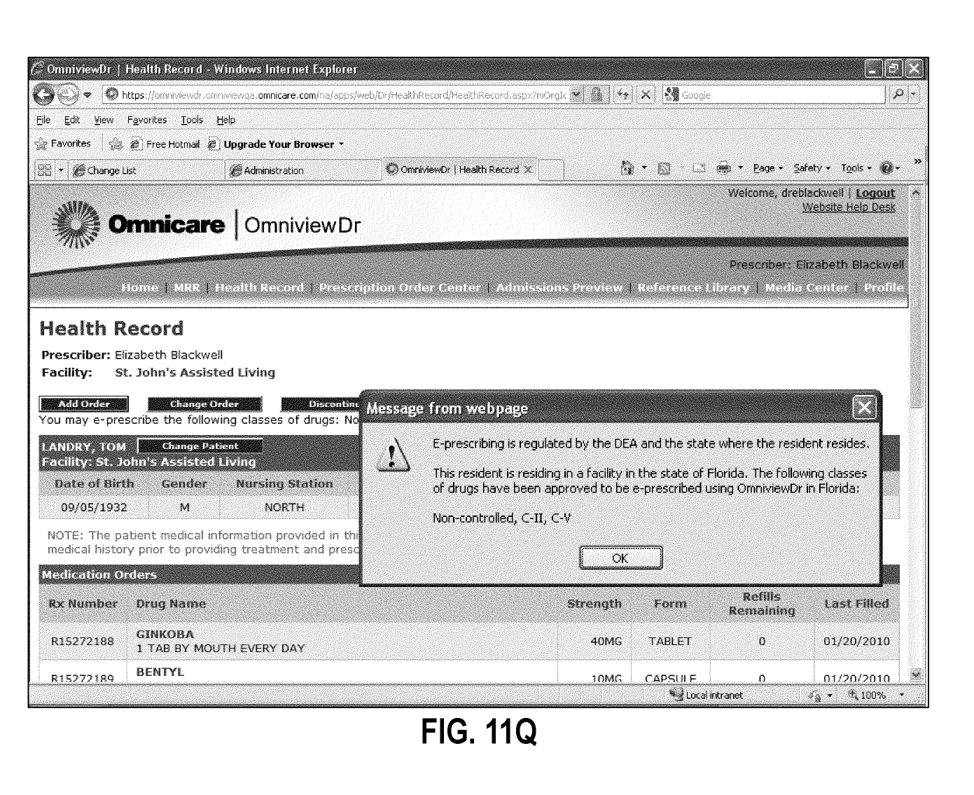

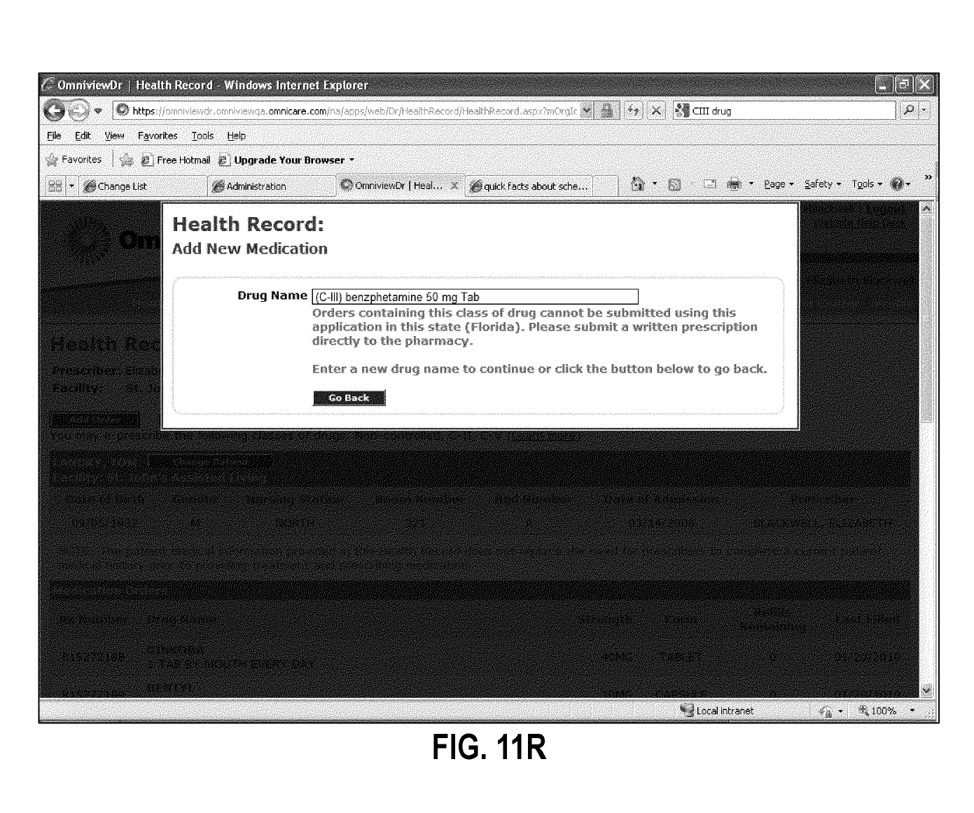

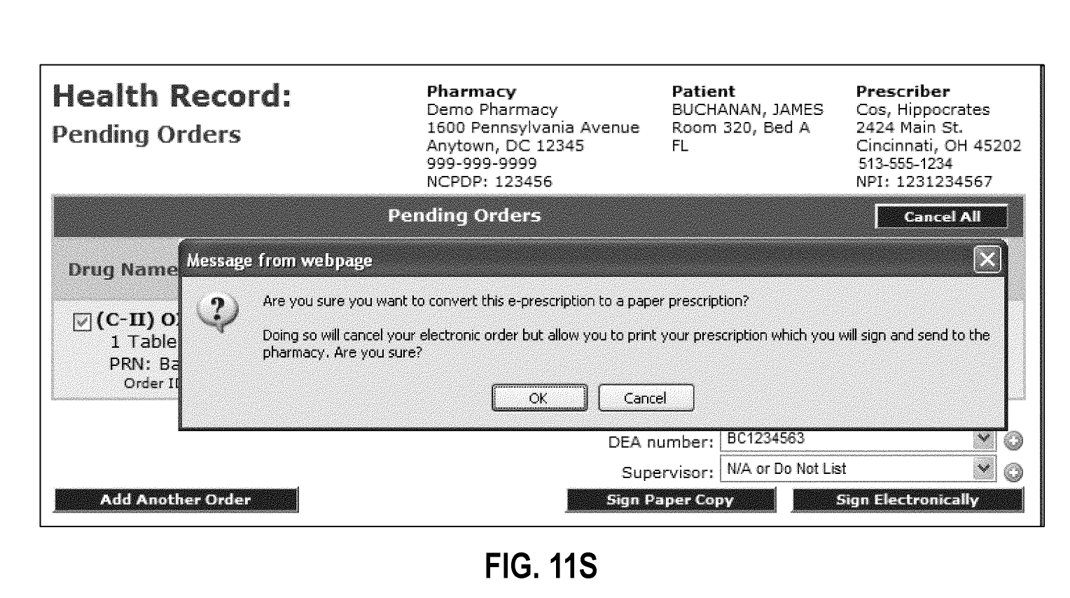

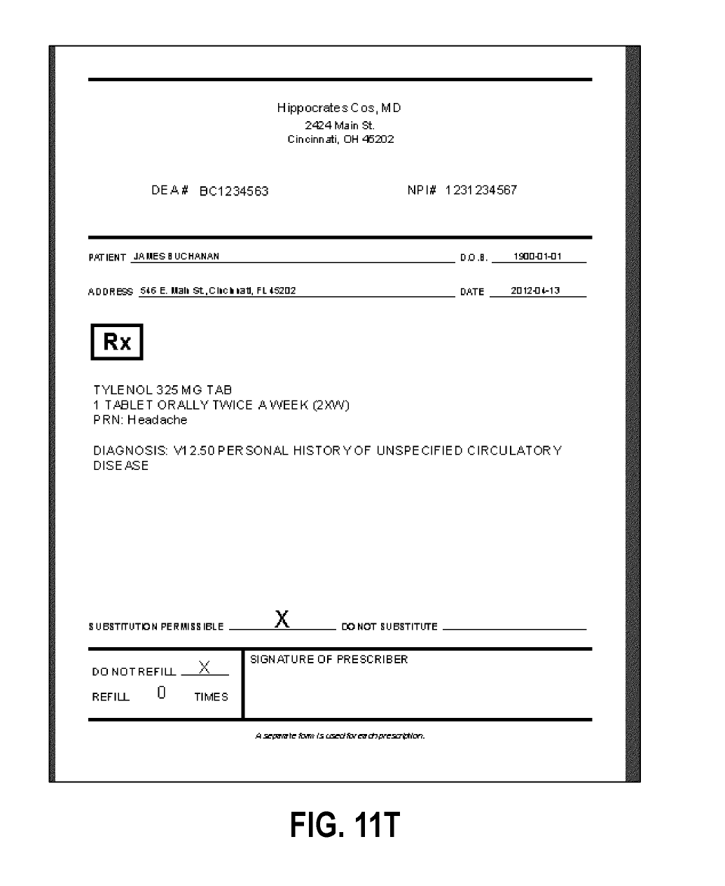

Turning now to FIGS. 11A-T, these figures provide example illustrations of application data that may be output on a display (i.e., an HMI 132) of a user device 102 consistent with embodiments of the invention when interfacing with an application server 110 and/or verification server 112. As discussed previously, the application data and user input data may be communicated between the user device 102, the application server 110 and/or the verification server 112 via a web-based interface by navigating an Internet browser application 126 executing on the user device 102 to a network location associated with the web-based interface. In other embodiments, the application data and user input data may be communicated between the user device 102, the application server 110 and/or the verification server 112 by a dedicated application 126 executing on the user device 102 which provides an interface therebetween. In FIG. 11A, an example is provided of a log-in prompt screen that the user device 102 may output when navigated to the network location of the web-based interface of the application server 110. FIG. 11B provides an example screen that the user device 102 may display after providing valid log-in data at the log-in screen in FIG. 11A. As shown in FIG. 11B, the user device 102 may output a plurality of options from which a user may select a desired action by inputting user input data via the HMI 132 associated with the user device 102.

Referring to FIG. 11C, this figure provides an example screen that the user device 102 may output in response to user input data selecting to view health records of associated patients from the options shown in FIG. 11B, and/or user input data selecting to electronically prescribe a medication for a patient. As shown in FIG. 11C, one or more healthcare facilities associated with the user may be output to the user to select a healthcare facility from among the healthcare facilities. FIG. 11D provides an example screen that the user device 102 may output in response to user input data selecting a particular healthcare facility in FIG. 11C. As shown in FIG. 11D, the output application data may include a patient search field, where a user may provide input data to search for a particular patient. FIG. 11E provides an example screen that the user device 102 may output after receiving user input data for the patient search field of FIG. 11D, and the output application data may include one or more patients matching the input data for the search field.

FIG. 11F provides an example screen that the user device 102 may output in response to the application server 110 receiving user input data selecting a particular patient from the list of one or more patients shown in FIG. 11E. As shown in FIG. 11F, the output application data includes a data informing the user of the classes of drugs the user may electronically prescribe. In addition, in FIG. 11F, the user device 102 outputs buttons which may be selected by the user in order to perform different functions. Specifically, the user may select the ‘Add Order’ button, which may be selected to generate an electronic prescription. In response to the user selecting the ‘Add Order’ button in FIG. 11F, the application server 110 may communicate application data to the user device 102 for output such as the example screen shown in FIG. 11G.

In FIG. 11 G, the user may input data into one or more prescription data fields output on the user device 102 including the ‘Drug Name’ (i.e., medication), ‘Dose Quantity’, ‘Route’, ‘Frequency’, ‘As Needed’, ‘Prescribed Quantity’, ‘Refills’, ‘Earliest Fill Date’, and/or ‘Diagnosis’ fields. Furthermore, as shown in FIG. 11G, in this example, the user may select the ‘Add Order’ button after completing data input into the prescription data fields output by the user device 102. Moreover, as discussed previously, one or more of the prescription data fields may be updated based on data input to other prescription data fields. For example, the ‘Prescribed Quantity’ field may be modified based on the data input to the ‘Drug Name’ field and/or the ‘Route’ field. For example, if a liquid medication is input into the ‘Drug Name’ field, the ‘Prescribed Quantity’ field may limit the user to providing a quantity associated with liquid medications such as milliliters (mL) or drops (for an eye drop or other such medication). FIG. 11H illustrates an example screen illustrating completed prescription data fields. As described previously, the application data may be updated in response to user input data being received for one or more prescription data fields, FIG. 11H provides an example of such updating as shown in the ‘Diagnosis’ field. As shown, the application data directed to the ‘Diagnosis’ field has been updated from FIG. 11H based on the user input in one or more of the other prescription data fields. In this example, common diagnoses associated with a prescription of ‘OxyContin 20 mg 12 hr Tab’ are presented in the ‘Diagnosis’ field, including an International Statistical Classification of Diseases and Related Health Problems (ICD-9) code associated with each common diagnosis.

After the user has completed the prescription data fields and indicated that the input is complete (e.g., by selecting the ‘Add Order’ button shown in FIG. 11G), FIG. 11I provides an example screen of output application data by the user device 102 including data for the completed prescription fields, the patient, the user (e.g., a physician), and an associated pharmacy for the user to review. In FIG. 11I, the user device 102 may receive input data from the user selecting the ‘Sign Electronically’ button or the ‘Sign Paper Copy’ button if the user desires to fill the prescription.

In response to the user indicating the desire to sign electronically (e.g., selecting the ‘Sign Electronically’ button in FIG. 11I), the application server 110 communicates application data to the user device 102 which prompts the user to input identification data. FIG. 11J provides an example screen prompting the user to input identification data in the form of a ‘Password’ for the interface as well as a ‘One Time Password’. In addition, as shown in FIG. 11J, the user may select from among a plurality of methods for receiving the one time password. As shown in FIG. 11K, the output application data of FIG. 11J may be updated responsive to the one time password being communicated to the user via the selected method, where the output application data indicates to the user that the one-time password (OTP) has been sent. FIG. 11L provides example output data illustrating the user having input data into the ‘Password’ and ‘One Time Password’ fields. If the input data for the identification data fields is correct, the electronic prescription may be signed, processed, and communicated to the pharmacy. FIG. 11M provides an example screen of output application data for informing the user that the electronic prescription has been successfully submitted to the pharmacy. As shown, the output application data may include a ‘Print’ button which allows the user to print a copy of the transmitted prescription. FIG. 11N provides an example screen of application output data including an image of the copy of the transmitted prescription.

Returning to FIG. 11E, the user may select a patient from the provided list, and FIG. 11O provides another example screen that may be output responsive to the user selecting a patient. As shown the user may be notified of classes of drugs that may be electronically prescribed for the geographic region in which the selected patient is located. Similarly, FIG. 11P provides an example screen that may be output responsive to the user selecting a patient associated with a geographic region in which only particular classes or schedules of drugs may be electronically prescribed. As shown, the user may be notified of the particular classes of drugs that the user is allowed to electronically prescribe. FIG. 11Q provides an example screen that may be output responsive to the user selecting a patient associated with a geographic region in which electronic prescribing is not permitted. As shown, the user may be notified that the user cannot electronically prescribe medications for the selected patient. With reference to FIGS. 11G and 11P, FIG. 11R provides an example screen that may be output responsive to the user inputting a medication of an impermissible class into the ‘Drug Name’ field.

Returning to FIG. 11I, the user may select to sign a paper copy of the prescription by selecting the ‘Sign Paper Copy’ button. FIG. 11S provides an example screen that may be output responsive to such selection to confirm that the user wishes to convert the electronic prescription to a paper prescription. FIG. 11T provides an example screen of an image of a prescription that may be output to the user device 102, such that the user may print the prescription with a printer associated with the user device 102 to create the paper prescription. While FIG. 11T shows over-the-counter medication, ‘Tylenol 325 Mg Tab’, as the substance appearing in the prescription image, the named substance in the prescription image may be, for example, ‘OxyContin 20 mg 12 hr Tab’, or any other substance consistent with the embodiments of the invention.

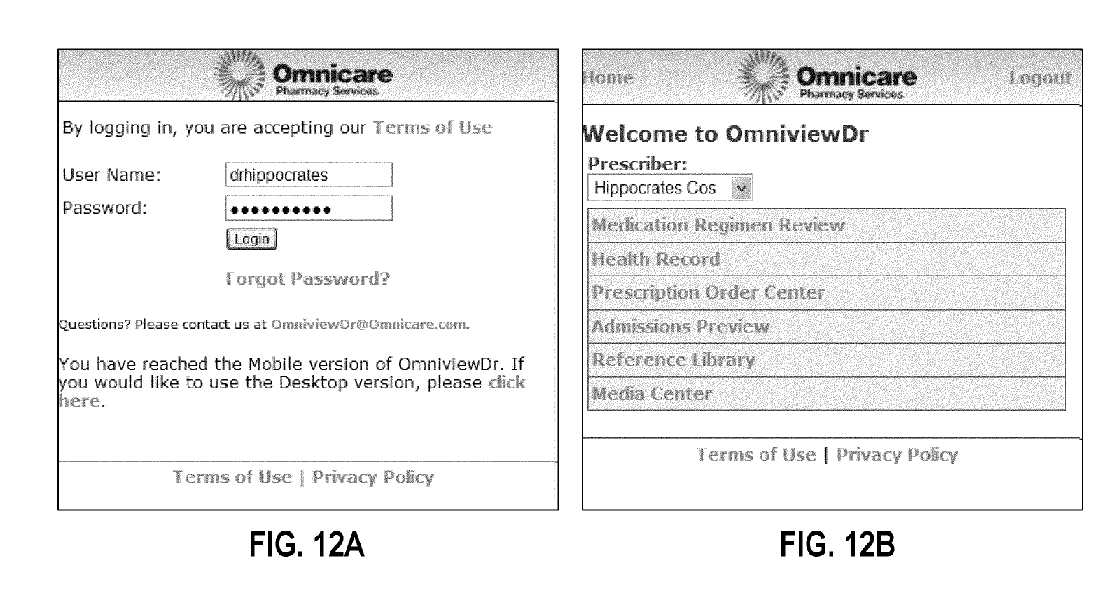

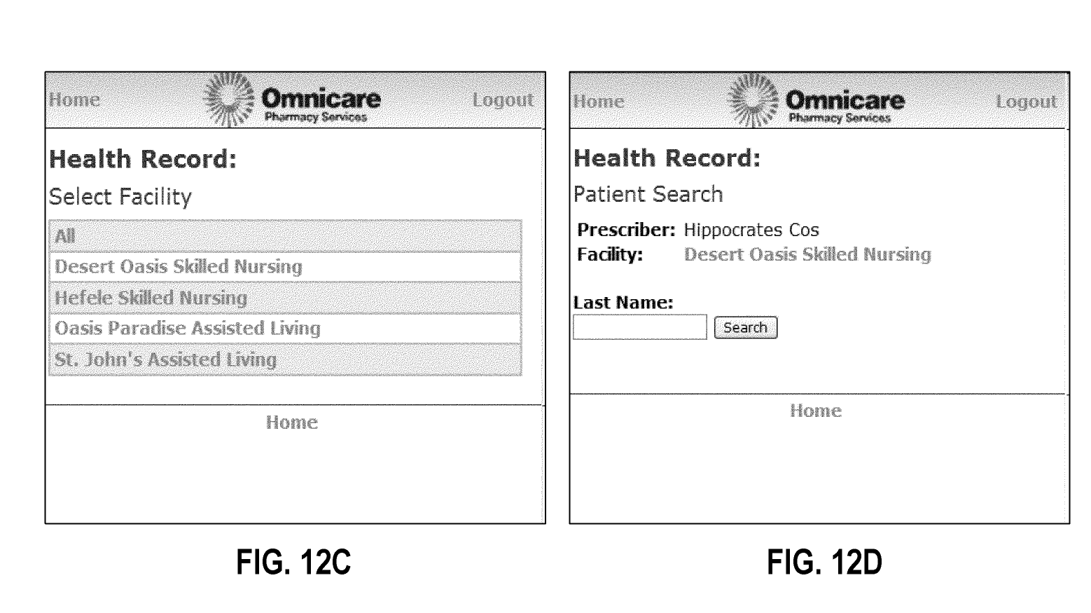

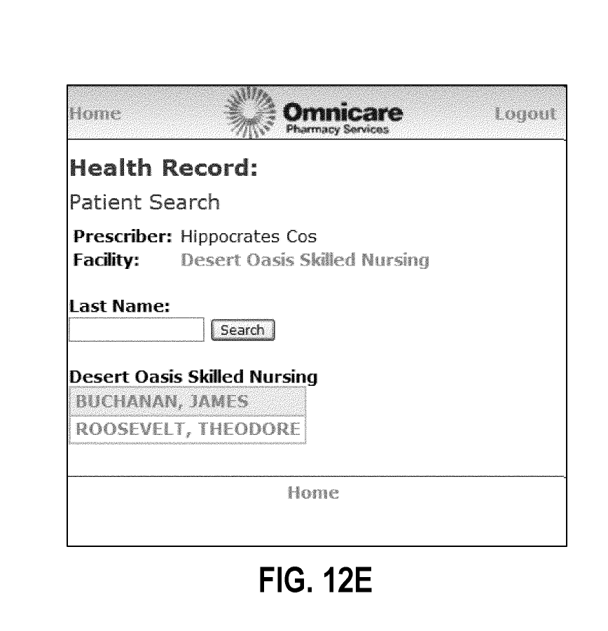

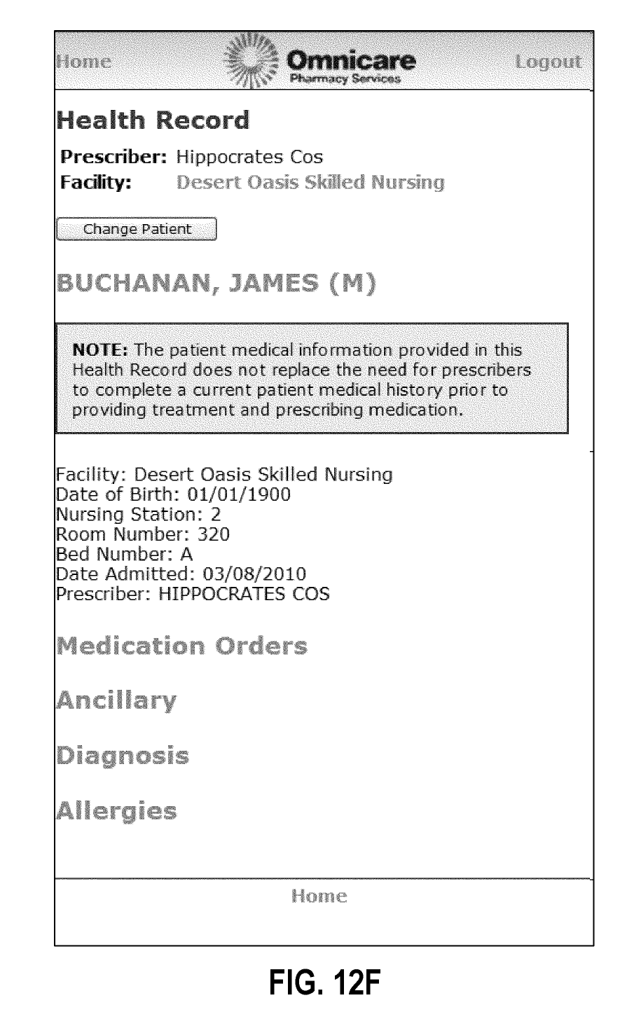

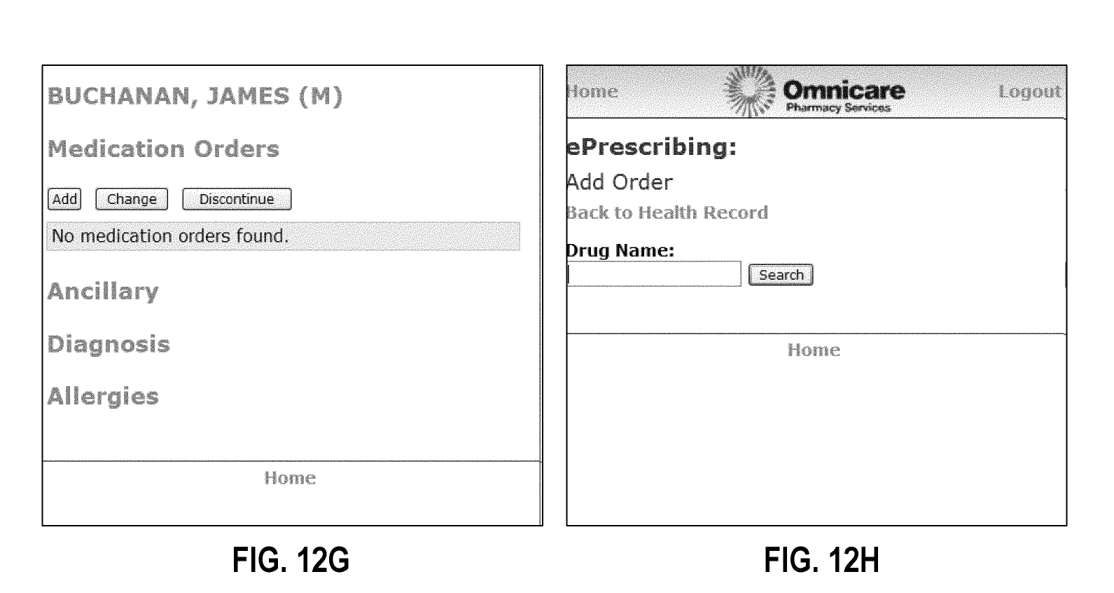

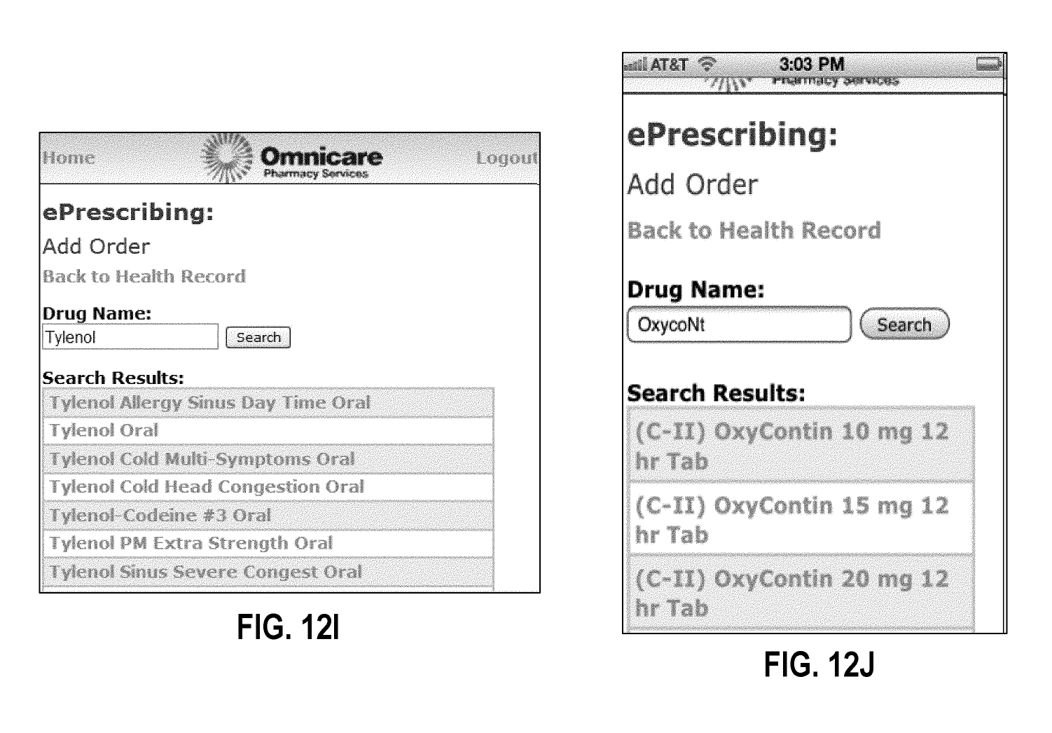

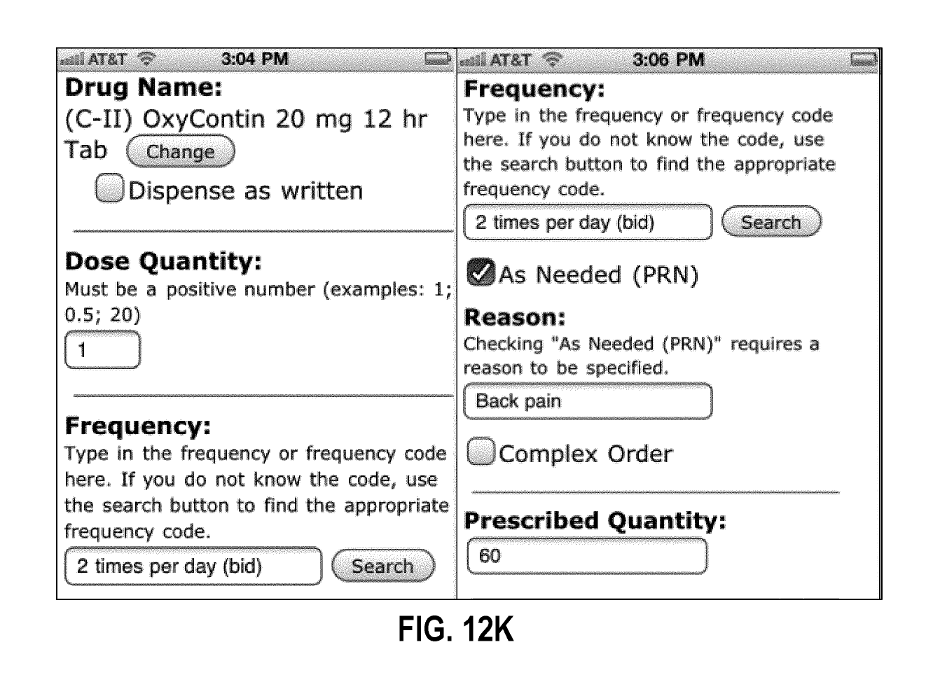

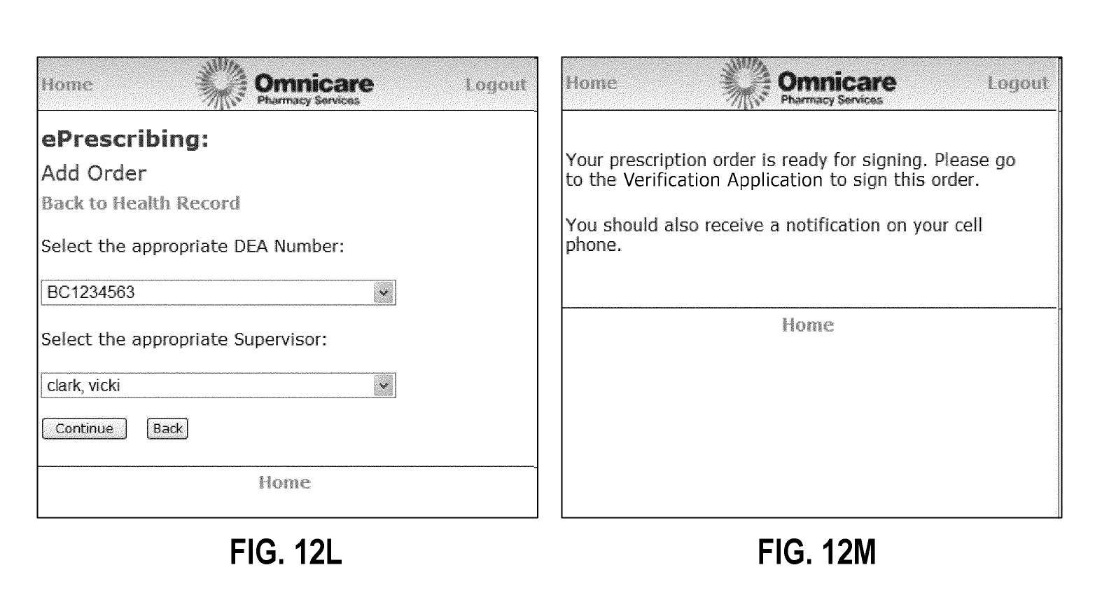

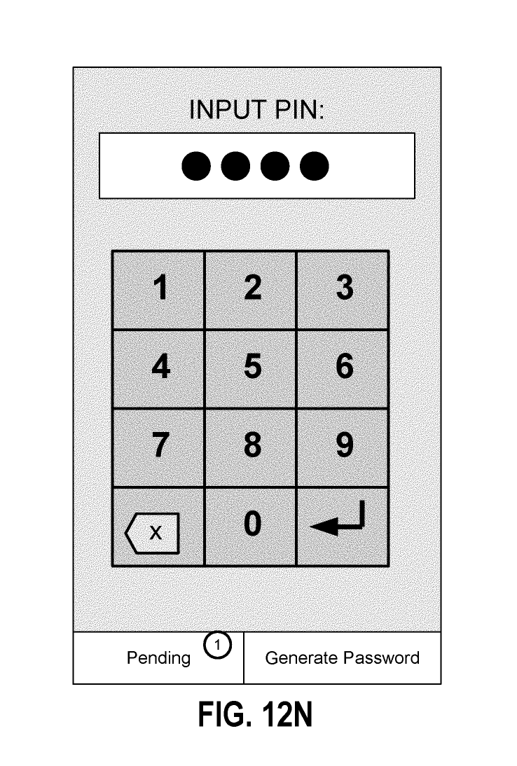

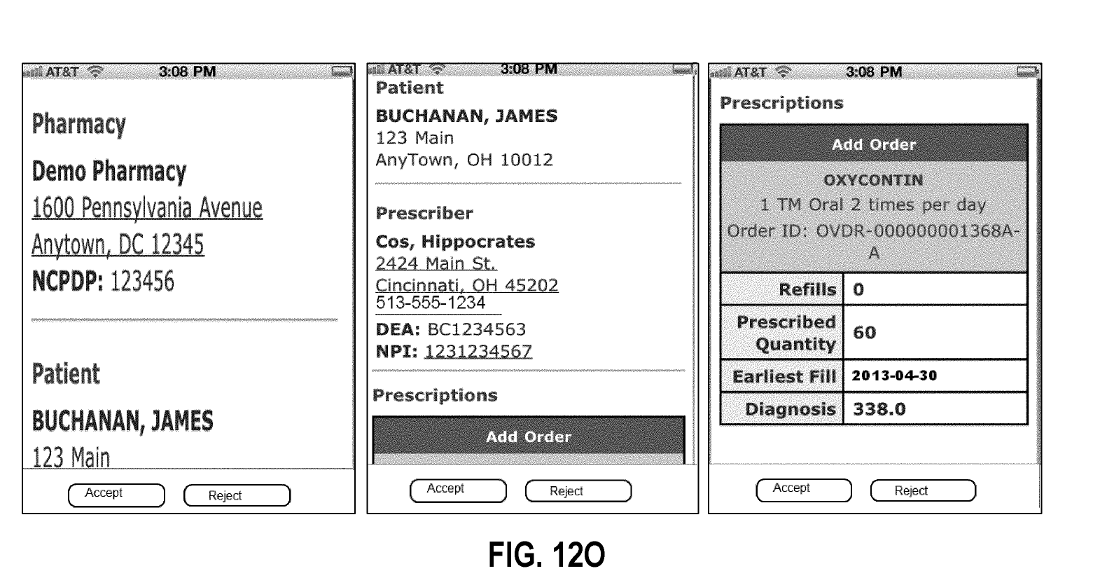

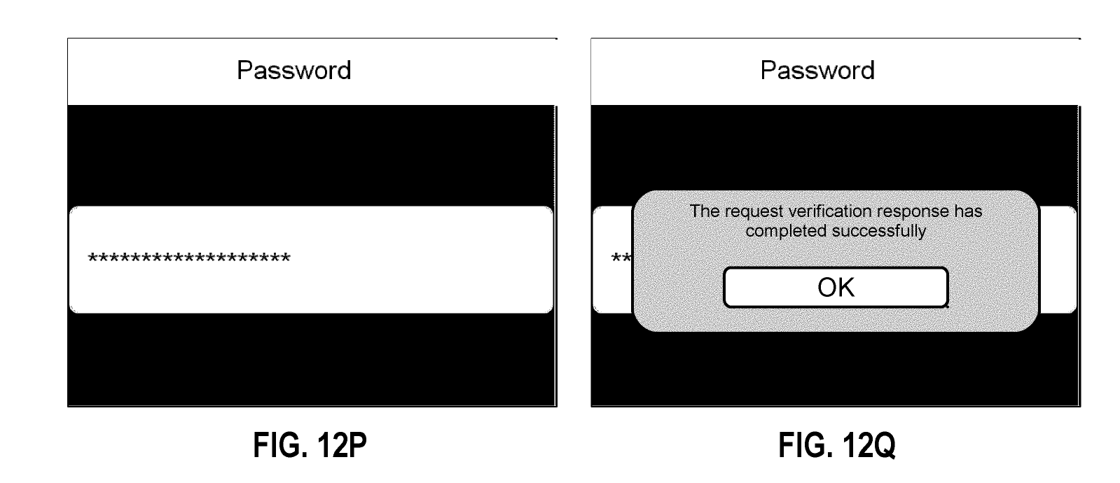

FIGS. 12A-Q provide example illustrations of application data that may be output on a display (i.e., an HMI) of a user device (for example, user device 106) consistent with embodiments of the invention when interfacing with an application server 110 and/or verification server 112. In this example one or more applications 126 may be executed by the user device 106 to interface with the application server 110 and/or verification server 112. FIG. 12A provides an example screen that may be output at the user device 106 to prompt a user to input log-in data. FIG. 12B provides an example screen that may be output at the user device 106 after a user logs in at FIG. 12A. FIG. 12C provides an example screen that may be output at the user device 106 to list one or more facilities associated with the user that the user may select a facility from. FIG. 12D provides an example screen that may be output at the user device 106 to prompt the user to provide input data into a patient search field. FIG. 12E provides an example screen that may be output at the user device 106 to list patients matching the data input to the patient search field in 12D. FIG. 12F provides an example screen that may be output at the user device 106 to provide a health record of a patient selected from the list of patients shown in FIG. 12E.

FIG. 12G provides an example screen that may be output at the user device 106 to provide medication order information for the selected patient in response to the user selecting the ‘Medication Orders’ option in FIG. 12F. FIG. 12H provides an example screen that may be output at the user device 106 to prompt the user to input data into a ‘Drug Name’ search field in response to the user selecting the ‘Add’ button in FIG. 12G. FIGS. 12I and 12J provide example screens that may be output at the user device 106 to list medications matching the data input into the ‘Drug Name’ search field in FIG. 12H. FIG. 12I provides an example screen of an over-the-counter medication, ‘Tylenol’, and FIG. 12J provides an example screen of a class 2 controlled substance, ‘OxyContin’. FIG. 12K provides an example screen that may be output at the user device 106 to present the user with a plurality of prescription data fields for user input data associated with a medication selected from the list of medications provided in FIG. 12I or 12J. FIG. 12L provides an example screen that may be output at the user device 106 to prompt the user to select a DEA identification number associated with a user authorized to sign the prescription and a supervisor. FIG. 12M provides an example screen that may be output at the user device 106 to inform the user that the prescription is ready to be signed by an authorized user.

FIG. 12N provides an example screen that may be output at the user device 106 prompting the user to provide identification data to view pending prescriptions. FIG. 12O provides a scrollable example screen that may be output at the user device 106 to provide prescription data for a pending prescription after the user correctly inputs the identification data in FIG. 12N. FIG. 12P provides an example screen that may be output at the user device 106 to prompt the user to input identification data in response to the user selecting the ‘Accept’ button of FIG. 12O. FIG. 12Q provides an example screen that may be output at the user device 106 to inform the user that identity verification based on the identification data entered in FIG. 12P completed successfully.

The electronic prescribing system described herein may be embodied in a secure, web-based application that permits users, such as physicians, to effectively and efficiently manage the needs of residents in facility, such as long term care and assisted living settings. In addition, the electronic prescribing system may permit a user not authorized to sign an electronic prescription, such as an assistant or nurse, to input prescription data and notify an authorized user (e.g., a physician) that an electronic prescription is pending for the authorized user to sign. The electronic prescribing system may supply other functionalities. For example, the electronic prescribing system may display each resident's medications, including dosages, frequency, prescription numbers, known allergies, patient diagnosis, and any ancillary orders needed to assure appropriate care. The electronic prescribing system may permit users to receive and reconcile drug regimen reviews for patients in their care and may send electronic notifications to alert the physician of new drug regimen reviews to allow for response to the pharmacist or facility online. The electronic prescribing system may provide the user to access searchable and/or printable reference libraries to provide information on various health care topics. The electronic prescribing system may alert users of important events, such as when a consultant pharmacist makes patient comments or recommendations or when an end-of-day drug regimen report is available. The electronic prescribing system may supply wellness center resources to the user in the form of tips and insights to help residents maintain a healthy lifestyle and stay fit.

The applications described herein generally comprise one or more instructions stored as program code that may be read from a memory by a processor and which may cause the processor to perform one or more operations when executed by the processor to thereby perform the steps necessary to execute steps, elements, and/or blocks embodying the various aspects of the invention. As such, the routines and/or instructions which may be executed by the processor to implement embodiments of the invention, whether implemented as part of an operating system or a specific application, component, program, object, module, or sequence of operations executed by the at least one processor will be referred to herein as “computer program code” or simply “program code”. Generally, program code may include routines, programs, objects, components, logic, data structures, and so on that perform particular tasks or implement particular abstract data types. Given the many ways in which program code embodied in a computer program may be organized into routines, procedures, methods, modules, objects, and the like, as well as the various manners in which program functionality may be allocated among various software layers that are resident within a typical computer (e.g., operating systems, libraries, API's, applications, applets, etc.), it should be appreciated that the embodiments of the invention are not limited to the specific organization and allocation of program functionality described herein.

The flowcharts, block diagrams, and sequence diagrams herein illustrate the architecture, functionality, and operation of possible implementations of systems, methods, and computer program products according to various embodiments of the present invention. In this regard, each block in a flowchart, block diagram, or sequence diagram may represent a module, segment, or portion of program code, which comprises one or more executable instructions for implementing the specified logical function(s). In certain alternative implementations, the functions noted in the blocks may occur in a different order than shown and described. For example, a pair of blocks described and shown as consecutively executed may be instead executed concurrently, or the two blocks may sometimes be executed in the reverse order, depending upon the functionality involved. Each block and combinations of blocks can be implemented by special purpose hardware-based systems that perform the specified functions or acts, or combinations of special purpose hardware and computer instructions.

The program code embodied in any of the applications described herein is capable of being individually or collectively distributed as a program product in a variety of different forms and, in particular, may be distributed using a computer readable media. Such computer readable media may include computer readable storage media and communication media. Computer readable storage media, which is non-transitory in nature, may include volatile and non-volatile, and removable and non-removable media implemented in any method or technology for storage of information, such as computer-readable instructions, data structures, program modules or other data. Computer readable storage media may further include RAM, ROM, erasable programmable read-only memory (EPROM), electrically erasable programmable read-only memory (EEPROM), flash memory or other solid state memory technology, CD-ROM, digital versatile disks (DVD), or other optical storage, magnetic cassettes, magnetic tape, magnetic disk storage or other magnetic storage devices, or any other medium that can be used to store the desired information and which can be read by a computer. Communication media may embody computer readable instructions, data structures or other program modules. By way of example, and not limitation, communication media may include wired media such as a wired network or direct-wired connection, and wireless media such as acoustic, RF, infrared and other wireless media. Combinations of any of the above may also be included within the scope of computer readable media.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. Furthermore, to the extent that the terms “includes”, “having”, “has”, “with”, “comprised of”, or variants thereof are used in either the detailed description or the claims, such terms are intended to be inclusive in a manner similar to the term “comprising.”

While the invention has been illustrated by a description of various embodiments and while these embodiments have been described in considerable detail, it is not the intention of the applicants to restrict or in any way limit the scope of the appended claims to such detail. In particular, any of the blocks of the above flowcharts may be deleted, augmented, made to be simultaneous with another, combined, or be otherwise altered in accordance with the principles of the invention. Additional advantages and modifications will readily appear to those skilled in the art. The invention in its broader aspects is therefore not limited to the specific details, representative methods, and illustrative examples shown and described. Accordingly, departures may be made from such details without departing from the spirit or scope of applicants' general inventive concept.

What is claimed is:

1. A method for generating an electronic prescription, the method comprising:
receiving user input data at an application server, the user input data identifying a particular facility and a particular patient;
generating, with a processor of the application server, application data for electronic prescribing for the particular patient based at least in part on the particular facility and the particular patient;
receiving prescription data for the particular patient at the application server; and
generating, with the processor of the application server, the electronic prescription based at least in part on the prescription data.

2. The method of claim 1 further comprising:
selecting at least one prescription rule stored in a prescription rules database based at least in part on the particular facility,
wherein the application data for electronic prescribing for the particular patient is based at least in part on the at least one selected prescription rule.

3. The method of claim 2 further comprising:
accessing a facility record associated with the particular facility stored in a facility database to determine a geographic region associated with the particular facility,
wherein the at least one prescription rule is selected based at least in part on the geographic region associated with the particular facility.

4. The method of claim 3 wherein the at least one prescription rule indicates whether electronic prescribing is permitted in the geographic region associated with the particular facility and the application data is generated based at least in part on whether electronic prescribing is permitted in the geographic region associated with the particular facility.

5. The method of claim 4 wherein generating the application data for electronic prescribing for the particular patient, receiving prescription data for the particular patient, and generating the electronic prescription are responsive to the at least one selected rule indicating that electronic prescribing is permitted in the geographic region associated with the particular facility.

6. The method of claim 1 wherein the user input data that identifies the particular facility is received prior to the user input data that identifies the particular patient, and further comprising:
receiving log-in data that identifies a particular user; and
determining at least one facility associated with the particular user,
wherein the application data for electronic prescribing for the particular patient is generated by selecting the particular facility based at least in part on the at least one facility associated with the particular user.

7. The method of claim 6 further comprising:
determining at least one patient associated with the particular user and the particular facility,
wherein the application data for electronic prescribing for the particular patient is generated by selecting the particular patient based at least in part on the at least one patient associated with the particular user and the particular facility.

8. The method of claim 1 further comprising:
at the application server, interfacing with a user device by communicating the application data to the user device; and
receiving the user input data and the prescription data at the application server from the user device.

9. The method of claim 8 further comprising:
receiving the application data at the user device;
processing the application data at the user device including outputting prescription field data at the user device;
receiving user input data for the prescription field data at the user device; and
transmitting the prescription data based on the user input data for the prescription field data to the application server.

10. The method of claim 1 further comprising:
prior to generating the electronic prescription based on the prescription data:
generating application data including an identification data field; and
receiving verification data from a verification server indicating whether an identification data input into the identification data field is verified or not verified,
wherein the electronic prescription is generated based at least in part on whether the identification data input into the identification data field is verified.

11. The method of claim 10 further comprising:
in response to receiving the verification data, transmitting prescription data from the application server to the verification server; and
receiving signed prescription data for the electronic prescription at the application server from the verification server.

12. A computer program product comprising a computer readable storage medium and program code stored on the computer readable storage medium and configured upon execution by the processor of the application server to cause the application server to perform the method of claim 1.

13. A method for processing an electronic prescription comprising a prescription image, the method comprising:
analyzing the prescription image to determine a user certificate database location and a signature code from the user certificate database location with a processor of an application server;
communicating the determined user certificate database location and the signature code to a verification server; and
receiving validation data from the verification server at the application server indicating whether the prescription image is valid or invalid.

14. The method of claim 13 further comprising:
at the verification server, decoding the signature code based at least in part on a user certificate stored at the user certificate location in a user certificate database accessible by the verification server; and
determining whether the decoded signature code corresponds to a digital signature associated with the user certificate stored in a digital signature database accessible by the verification server; and
generating the validation data based at least in part on whether the decoded signature code corresponds to the digital signature.

15. The method of claim 13 further comprising:
if the prescription image is valid, transmitting the prescription image from the application server to a pharmacy server.

16. A method for signing prescription data, the method comprising:
receiving prescription data and a request for identification data transmission from an application server at a verification server;
in response to receiving the request at the verification server, generating first identification data for a particular user based at least in part on the request;
transmitting the first identification data from the verification server to a user device associated with the particular user;
receiving second identification data at the verification server;
analyzing the second identification data to determine whether the second identification data corresponds to the first identification data;
if the second identification data corresponds to the first identification data, signing the prescription data.

17. The method of claim 16 wherein signing the prescription data comprises:
generating a signature code based on a user certificate stored in a user certificate database at a user certificate location and a digital signature associated with the user certificate,
wherein the prescription data is signed by including the signature code and data indicating the user certificate location in the prescription data.

18. The method of claim 16 wherein the prescription data and the request for the identification data transmission are generated at a first user device, and the user device indicated in the request for the identification data transmission is a second user device.

19. A system for processing electronic prescriptions, the system comprising:
a processor; and
program code configured to be executed by the processor to cause the processor to receive user input data, the user input data identifying a particular facility and a particular patient, generate application data for electronic prescribing for the particular patient based at least in part on the particular facility and the particular patient, receive prescription data for the particular patient, and generate an electronic prescription based at least in part on the prescription data.

20. The system of claim 19 wherein the program code is further configured to cause the processor to select at least one prescription rule stored in a prescription rules database based at least in part on the particular facility,
wherein the application data for electronic prescribing for the particular patient is based at least in part on the at least one prescription rule.
